(19) United States
(12) Patent Application Publication
(10) Pub. No.: US 2002/0138254 A1
(43) Pub. Date: Sep. 26, 2002

(54) Method and apparatus for processing speech signals

(76) Inventors: Takehiko Isaka, Kobe-shi (JP); Yoshifumi Nagata, Morioka-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/101,205

(22) Filed: Mar. 20, 2002

Related U.S. Application Data
(62) Division of application No. 09/116,908, filed on Jul. 17, 1998.

(30) Foreign Application Priority Data
Jul. 18, 1997 (JP) 9-194036
Jul. 31, 1997 (JP) 9-206366

(51) Int. Cl. G10L 11/06; G10L 21/00

(52) U.S. Cl. 704/208

(57) ABSTRACT

A speech processing apparatus comprises a speech input section which receives multi-channel signals, a beam former processing section for performing beam former processing on the multi-channel signals to suppress a signal arriving from a target speech source, a target source direction estimation section for estimating the direction of the target source from filter coefficients resulting from the beam former processing, and a voiced/unvoiced speech determination section for determining a speech interval of a speech signal on the basis of the estimated direction of the target source.

### BACKGROUND OF THE INVENTION

The present invention relates to a speech signal processing method and apparatus for detecting a speech interval of an input speech signal and enhancing the speech signal by suppressing noise.

This application is based on Japanese Patent Applications No. 9-194036, filed Jul. 18, 1997, and No. 9-206366, filed Jul. 31, 1997, the entire contents of which are incorporated herein by reference.

More specifically, the present invention relates to a speech signal processing apparatus and method for processing a microphone array signal obtained from an array of microphones to take out a target speech signal therefrom by suppressing noise for the purpose of inputting speech signals into a speech recognition apparatus, teleconference apparatus, or the like.

As a method of detecting a speech interval in a noise environment, there is a method of detecting the speech interval using the energy of a signal and the number of times the signal passes through the zero value (the number of zero crossings) as disclosed in literature 1: “Speech Recognition” by Yasunaga Niimi, Kyoritsu Shuppan. With this method, however, it is difficult to detect the speech interval accurately when the signal-to-noise ratio is very low.

In order to allow the entry of speech signals in an environment where the S/N ratio is low, a microphone array-based noise suppression process has been studied. For example, in literature 2: Acoustic System and Digital Processing edited by the Institute of Electronics, Information and Communication Engineers, a method is described which improves the S/N ratio using an adaptive microphone array of a small number of microphones. With this method, however, it is difficult to improve the S/N ratio in such an environment as there are so many noise sources that their directions cannot be identified. For this reason, it is difficult to detect the speech interval on the basis of the output power of the microphone array.

As described above, the method for improving the S/N ratio using a microphone array based on a small number of microphones has a problem that, since an improvement in the S/N ratio cannot be expected in an environment in which the directions of noise sources cannot be identified, it is difficult to detect the speech interval accurately using the output power of the microphone array.

### BRIEF SUMMARY OF THE INVENTION

It is an object of the present invention to provide a speech processing method and apparatus which permit a speech interval of a target speech signal to be detected accurately using a small number of microphones even in such an environment as the S/N ratio is so low that the directions of noise sources cannot be identified.

It is another object of the present invention to provide a speech processing method and apparatus which permits a process of enhancing only speech signals to be performed with certainty by suppressing noise.

It is still another object of the present invention to provide a signal processing apparatus and method which permit the direction of signal arrival to be tracked with a straightforward arrangement without using a space search problem that involves a large amount of computation and therefore permits target signals to be extracted with high precision while circumventing cancellation of a target signal.

The present invention provides a signal processing method and apparatus which receive a speech signal over multiple channels, perform beam former processing on the multi-channel speech signals to suppress a signal arriving from a target speech source, estimate the direction of the target source from filter coefficients obtained by the beam former processing, and determine a speech interval of the speech signal on the basis of the estimated direction of the target source.

That is, the basic feature of the present invention is that digital operations, i.e., the beam former processing, are performed by a beam former on the multi-channel signals to suppress a signal from the target source, the direction of the target source is estimated from filter coefficients obtained by the beam former processing, and the speech interval of the speech signal is determined on the basis of the direction of the target source.

In such an environment as the direction of a noise source cannot be identified, it is difficult to improve the S/N ratio of the target source by the beam former. However, since the speech signal from the target source arrives from a certain direction, in the speech interval it is possible to estimate the direction of the target source from the filter coefficients in the beam former. The speech interval can be detected on the basis of the direction of the target speech source.

In addition, the present invention provides a speech signal processing method and apparatus which receive a speech signal over multiple channels, perform first beam former processing on the multi-channel speech signals to suppress a signal from a target speech source, estimate the direction of the target speech source on the basis of filter coefficients obtained by the first beam former processing, perform second beam former processing on the multi-channel speech signals to suppress a signal from a noise source and output the signal from the target speech source, estimate the direction of the noise source from filter coefficients obtained by the second beam former processing, control the second beam former processing on the basis of the estimated direction of the target source and output powers obtained by the first and second beam former processing, control the first beam former processing on the basis of the estimated direction of the noise source and the output powers obtained by the first and second beam former processing, and determine the speech interval of the speech signal on the basis of the estimated direction of the target source.

That is, in addition to the first beam former for suppressing a signal from the target source, the second beam former is provided for suppressing a signal from the noise source to output the signal from the target source. The direction of the noise source is estimated from filter coefficients obtained by the second beam former. The second beam former is controlled on the basis of the direction of the target source and the output powers obtained by the first and second beam formers. The first beam former is controlled on the basis of the direction of the noise source and the output powers obtained by the first and second beam formers.

Thus, even when there exists a noise source in some direction, the direction of the target source can be estimated with high accuracy by causing the input direction of the first beam former to follow the direction of the noise source, thereby allowing the speech interval to be detected with certainty.

In detecting the speech interval, the speech signal power may be used in addition to the estimated direction of the target source.

Moreover, the present invention is characterized by suppressing noise in the output of the second beam former and thereby enhancing the speech signal through the use of at least one of the output of the first beam former and the estimated direction of the target source.

In such an environment as there are so many noise sources that their directions cannot be identified, the beam former's noise suppressing capability is lowered. However, since an output signal containing only noise can be extracted by the first beam former having its input direction set to the direction of a noise source, speech enhancement processing can be performed on the output of the second beam former by a spectrum subtraction scheme using the noise output.

Where the directions of the target source and the noise sources are fixed and known, since the estimation of the direction of the target source and the controlling of the first and second beam formers are unnecessary, it is only required that the first beam former be directed to the most powerful noise source and the second beam former be directed to the target source. In this case, speech enhancement processing can be performed on the second beam former output on the basis of the first beam former.

Furthermore, in the present invention, it is also possible to detect the speech interval using the estimated direction of the target speech source and a speech-enhanced signal, which further improves the speech interval detecting capability.

A plurality of beam formers are provided which have their respective input directions set slightly different. The output powers of the beam formers are compared to detect which of the input directions of the beam formers the actual signal arrival direction is closer to. The input direction of each beam former is simultaneously shifted little by little toward the actual signal arrival direction, thereby following the actual signal arrival direction.

This employs that the farther away the beam former's input direction is from the signal arrival direction, the lower its output becomes as a result of cancellation of a target signal.

This arrangement eliminates the need of computation-intensive space search processing and frequency-domain-based processing and, while being very simple, allows robust processing which is free of degradation due to cancellation of a target signal.

In addition, the present invention is further provided with an additional beam former in addition to the plurality of beam formers, which has its input direction set to the middle of the input directions of the beam formers.

The setting of the input direction of the additional beam former to the middle between the input directions of the plural beam formers allows that input direction to follow the signal arrival direction more accurately. Moreover, a target signal can be extracted more accurately by using the output signal of the additional beam former than with the output signal of one of the plural beam formers.

In this case, since the plural beam formers are used only for tracking and have no direct effect on the output signal, there is provided an advantage that the filter length of those beam formers can be reduced to decrease an overall amount of processing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments give below, serve to explain the principles of the invention.

FIG. 1 is a schematic representation of a speech processing apparatus according to a first embodiment of the present invention;

FIG. 2 shows an arrangement of the adaptive beam former processing section of FIG. 1;

FIG. 3 shows a beam former having a delay element inserted in one of its two input channels;

FIG. 4 is a flowchart for the sound source direction estimation procedure in the first embodiment;

FIG. 5 is a diagram for use in explanation of a time delay introduced between signals from two microphones;

FIG. 6 is a state transition diagram illustrating the process flow in a first method of discerning between speech and unvoiced speech signals in the first embodiment;

FIG. 7 is a state transition diagram illustrating the process flow in a second method of discerning between speech and unvoiced speech signals in the first embodiment;

FIG. 8 is a schematic representation of a speech processing apparatus according to a second embodiment of the present invention;

FIG. 9 shows a process flow in the second embodiment;

FIG. 10 is a schematic illustration of a speech processing apparatus according to a third embodiment of the present invention;

FIG. 11 is a schematic illustration of a speech processing apparatus according to a fourth embodiment of the present invention;

FIG. 12 is a schematic illustration of a speech processing apparatus according to a fifth embodiment of the present invention;

FIG. 13 is a schematic illustration of the two-channel spectrum subtraction-based speech signal enhancing section;

FIG. 14 is a flowchart for the procedure of enhancing a speech signal by the speech signal enhancing section of FIG. 13;

FIG. 15 is a schematic representation of a speech signal processing apparatus according to a sixth embodiment of the present invention;

FIG. 16 is a schematic representation of a speech signal processing apparatus according to a seventh embodiment of the present invention;

FIG. 17 is a schematic illustration of the beam former;

FIG. 18 is a diagram for explaining that a time delay to be introduced into an m-th-channel signal Schm can be sought from the direction of incoming signal set in the beam former;

FIG. 19 is a block diagram of the GSC shown in FIG. 17;

FIG. 20 is a diagram for use in explanation of the present invention;

FIG. 21 shows an example of a process flow in the seventh embodiment of the present invention;

FIG. 22 is a schematic illustration of a speech signal processing apparatus according to an eighth embodiment of the present invention;

FIG. 23 is a diagram for use in explanation of the present invention;

FIG. 24 is a diagram for use in explanation of the present invention;

FIG. 25 is a diagram for use in explanation of the present invention;

FIG. 26 shows an example of a process flow in the eighth embodiment of the present invention;

FIG. 27 is a schematic illustration of a speech signal processing apparatus according to a ninth embodiment of the present invention;

FIG. 28 is a diagram for use in explanation of the present invention;

FIG. 29 is a diagram for use in explanation of the present invention;

FIG. 30 shows an example of a process flow in the ninth embodiment of the present invention;

FIG. 31 is a schematic illustration of a speech signal processing apparatus according to a tenth embodiment of the present invention; and

FIG. 32 shows an example of a process flow in an eleventh embodiment of the present invention.

### DETAILED DESCRIPTION OF THE INVENTION

A first embodiment of the present invention will be described in terms of a speech signal processing apparatus which has a function of estimating the direction of a target speech source from a speech signal received over multiple channels and detecting a speech interval.

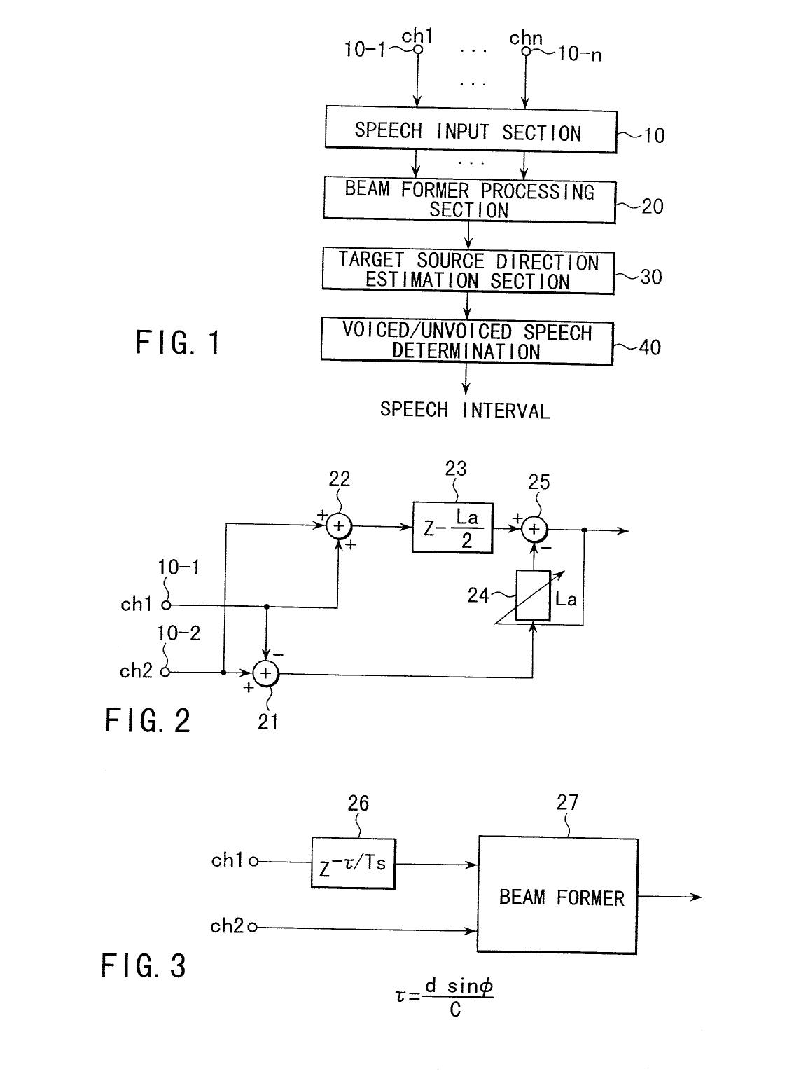

The speech signal processing apparatus comprises, as shown in FIG. 1, a speech input section 10 which receives an incoming speech signal over multiple channels ch1 to chn (a number n of channels) and corresponding input terminals 10-1 to 10-n, a beam former processing section (beam former) 20 which performs a beam former process on the incoming speech signal for suppressing a signal that arrives from a target speech source, a target speech direction estimation section 30 which estimates the target speech direction from filter coefficients obtained by the beam former processing section 20, and a voiced/unvoiced speech determination section 40 which determines whether an incoming signal is a speech signal or an unvoiced signal on the basis of time series of target speech direction and either or both of time series for the power of the signal obtained from the speech input section 10 and time series for interchannel correlation of the signal obtained from the speech input section.

In the following description, the number of channels is taken to be two for simplicity.

The beam former processing section 20 performs filtering computation, called adaptive beam former processing, on a signal from the speech input section 10 for suppressing a target speech source. As the processing by the beam former processing section 20, various known methods are known, which, as described in the previously mentioned literature 2 and literature 3: “Adaptive Filter Theory” (Plentice Hall) by Heykin, include the generalized sidelobe canceller (GSC), the frost type beam former, the reference signal method, and so on. Any type of adaptive beam former can be adapted for the present invention. A two-channel GSC will be described here by way of example.

In FIG. 2 there is illustrated, as an example of a beam former, an arrangement of a Jim-Griffith type GSC which is standard among two-channel GSCs. This GSC comprises a subtracter 21, an adder 22, a delay element 22, an adaptive filter 24, and a subtracter 25. As the adaptive filter 24, there are various types of filters available, including the LMS, the RLS, and the projective LMS filters. The filter length La is set to, for example, 50. The amount of delay introduced by the delay element 23 set to, for example, La/2.

Using an LMS adaptive filter as the adaptive filter 24 in the two-channel Jim-Griffith type GSC of FIG. 2 that forms the beam former 20 and putting W(n) as coefficients of the adaptive filter 24, xi(n) as the input signal on the i-th channel, Xi(n) (=xi(n), xi(n−1), . . . , xi(n−La+1)) as the input signal vector on the i-th channel where n is time, updates of the filter are represented by

y(n)=x0(n)+x1(n) (1)

X′(n)=X1(n)−X0(n) (2)

e(n)=y(n)−W(n)X′(n) (3)

W(n+1)=W(n)−μX′(n)e(n) (4)

The input direction of the GSC of FIG. 2 is set to a direction other than the direction of the target speech source, for example, the direction of 90° with respect to the direction of the target speech source. Here, a time delay difference is introduced between signals on two channels so that signals from the set input direction will arrive at the array at the same time. To this end, as shown in FIG. 3, a delay element 26 is inserted in the channel 1 of the two input channels of the beam former 20 of FIG. 2 which is indicated at 27 in FIG. 3. When the input direction is set to 90°, the delay time introduced by the delay element 26 is set to τ=d/c where c is the velocity of sound and d is the distance between microphones.

When a signal arrives from the direction of the target speech source, the direction of the target source can be estimated by examining directivity, which represents the dependence of sensitivity on direction, from filter coefficients of the filter in the beam former 20 the sensitivity of which declines for the direction of the target source.

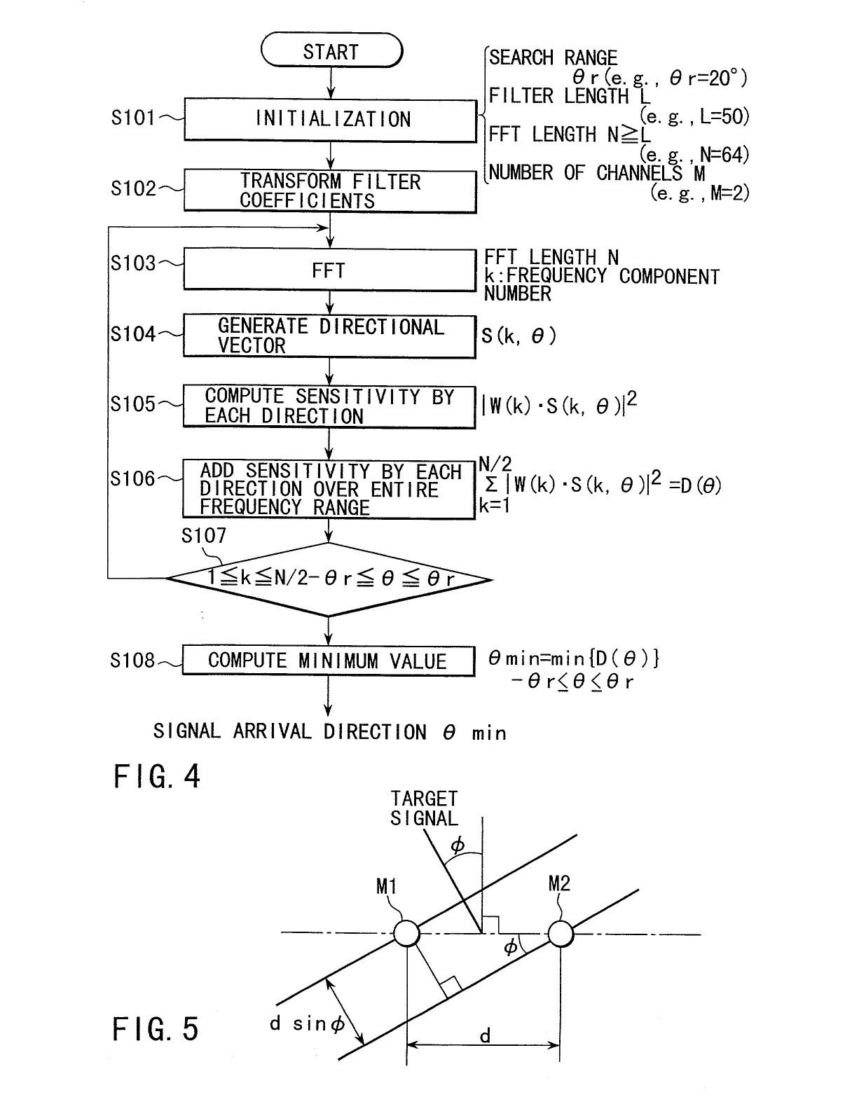

FIG. 4 shows the procedure for estimating the direction of the target speech source by the target speech source direction estimation section 30. First, a search range θr over which the target direction is searched for, the filter length L, the FFT (Fast Fourier Transform) length (the number of FFT points) N, the number of channels M are initialized (step S101). For example, assume that θr=20°, L=50, N=64, and M=2. The beam former searches through only a range of directions from which the target source signal arrives: therefore, the search angle range is set to within ±θr with respect to the direction of the target source.

Next, if the beam former is a GSC, the filter coefficients are transformed into a form equivalent to a transversal type of beam former (step S102). With two-channel Jim-Griffith type GSC by way of example, if the coefficients of the GSC adaptive filter are

wg=(w0, w1, w2, . . . , wL−2, wL−1),

then it is required that the coefficients of the first-channel (ch1) equalization filter be

we1=(−W0, −W1, −W2, . . . , −WL/2+1, . . . , −WL−1, −WL−2)

and the coefficients of the second-channel (ch2) equalization filter be

we2=(w0, w1, w2, . . . , wL/2−1, . . . , wL−2, WL−1).

Next, the filter coefficients are subjected to FFT for each channel to seek frequency components Wei(k) (step S103). Here, k is the frequency component number and i is the channel number.

Next, with a certain direction within the range of search taken to be θ, a directional vector S(k, θ) is generated which represents the propagation phase delay associated with each channel for a signal that arrives from the θdirection (step S104). In the case of a microphone arrangement shown in FIG. 5, the directional vector S(k, θ) is represented with reference to the first channel ch1 as follows:

S(k, θ)=(i, exp(−j k/N fs d sin θ))

where fs is the sampling frequency and d is the distance between adjacent microphones.

Next, the square of the absolute value of inner product of the filter frequency component We=(We1(k), We2(k)) obtained by FFT and the directional vector S(k, θ), |S·W|², is computed to obtain the sensitivity by each direction (step S105).

The processes in steps S103 to S105 are performed for each of the frequency components from k=1 to k=N/2. The resulting squares are added in step S106 to yield the sensitivity by each direction over the entire frequency range, as follows:

D(θ)=Σ|W(k)·S(k, θ)|²

At this point, the direction is changed, for example, on a 1° by 1° basis to examine the sensitivity for all the directions within the range of search (step S107).

Next, the direction θmin at which the sensitivity is minimum is obtained from D(θ) and it is then estimated to be direction from which a signal (a signal from a speech source or noise source) arrives (step S108).

The processing by the voiced/unvoiced speech determination section 40 will be described next.

This section makes a determination of whether an incoming signal is a voiced speech signal or a unvoiced speech signal on the basis of time series of target speech direction estimated by the target speech source direction estimation section 30 and/or time series for incoming signal power. It is also possible to use time series for inter-channel correlation.

The voiced/unvoiced speech determination can be made through the use of one of two methods: (1) the method of using time series of target speech direction; and (2) the method of using time series of target speech direction and the power of an incoming signal.

The reason for using time series of target speech direction rather than the direction of a target source to determine whether an incoming signal is a speech signal or not is as follows: When no signal arrives from a target source, an incoming signal to the apparatus contains no directional signal and the estimated value for the direction of a target source will take random values. When a signal arrives from a target source, the estimated value for the direction of the target source takes values within a given range. When time series of target speech direction fall within a given range, an incoming signal can be regarded as a speech signal.

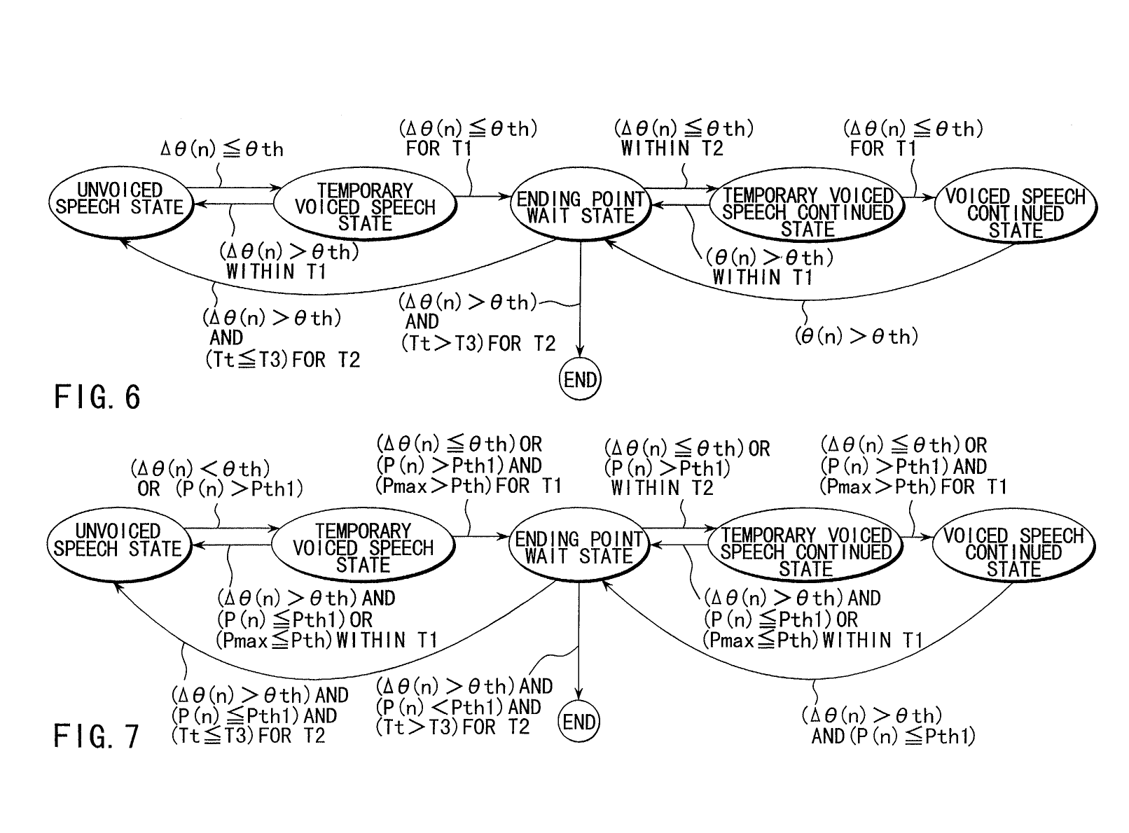

The procedure for determining whether an incoming signal is a speech signal or not in accordance with the method (1) will be described with reference to FIG. 6, which shows in state transition diagram form the process flow in making such a determination. An unvoiced speech state where no speech signal exists is taken as the starting point. Assume that the time series of target speech direction at time n is Δθ(n)=|θ(n)−θ(n−1)| and the maximum time series of target speech direction of θ(n) required to recognize an incoming signal as a segment of speech is θth (e.g., θth=5°). When the state where Δθ(n)≦θth is reached at a point of time, it is assumed that the point of time is a temporary starting point of speech. Then, a transition is made from the unvoiced speech state to the temporary speech state.

In the temporary speech state, it is assumed that the minimum time length required to recognize an incoming signal as a segment of speech is T1 (for example, T1=20 msec). If a state where Δθ(n)≦θth is reached within T1, then a return is made to the unvoiced speech state. Otherwise, a point of time at which the state where Δθ(n)>θth is reached is taken as a temporary ending point of speech, so that a transition is made to the ending point wait state to wait the determination of the end point of speech.

In the end point wait state, it is assumed that the minimum time length required to determine the end of speech is T2 (for example, T2=100 msec). If the state where Δθ(n)≦θth is reached within T2, then a transition is made to the temporary speech continuation state representing that speech is continuing. Otherwise, assuming a point of time at which the transition was last made to the end point wait state to be the temporary end point of speech, a return is made to the unvoiced speech state if the time interval between the temporary start point and the temporary end point is not more than the minimum time length T3 (for example, T3=300 msec) required to recognize an incoming signal as speech. Otherwise, a transition is made to the end state with the interval between the temporary start point and the temporary end point taken as a speech interval.

In the temporary speech continuation state, a return is made to the end point wait state if the state where Δθ(n)>θth is reached within T1; otherwise, a transition is made to the speech continuation state representing that speech is continuing.

In the speech continuation state, a transition is made to the end point wait state when the state where Δθ(n)>θth is reached.

Next, the procedure for determining whether an incoming signal is speech or not in accordance with the method (2) will be described with reference to FIG. 7. Here, two values Pth1 and Pth2 (Pth1>Pth2) are set as the minimum value for the power of an incoming signal required to recognize it as speech. In FIG. 7, the unvoiced speech state is taken as a starting point. Assume that the time series of target speech direction at time n is Δθ(n) and the maximum time series of target speech direction of θ(n) required to recognize an incoming signal as a segment of speech is θth. When the state where Δθ(n)≦θth or P(n)>Pth1 is reached at a point of time, it is assumed that the point of time is a temporary starting point of speech. Then, a transition is made from the unvoiced speech state to the temporary speech state representing that the temporary start point was found.

In the temporary speech state, a return is made to the unvoiced speech state if the state where Δθ(n)>θth and P(n)≦Pth1 is reached within T1 or the maximum value of P(n) is below the threshold value Pth until the state where Δθ(n)>θth and P(n)≦Pth1 is reached. Otherwise, a transition is made to the end point wait state indicating waiting the determination of the end point of speech. Here, Pth is the minimum value for the power of an incoming signal required to accept it as speech.

In the end point wait state, if the state where Δθ(n)≦θth or P(n)>Pth1 is reached within T2, then a transition is made to the temporary speech continuation state representing that speech is continuing. Otherwise, assuming a point of time at which the transition was last made to the end point wait state to be the temporary end point of speech, a return is made to the unvoiced speech state if the time interval between the temporary start point and the temporary end point is not more than T3 required to recognize an incoming signal as speech. Otherwise, a transition is made to the end state with the interval between the temporary start point and the temporary end point taken as a speech interval.

In the temporary speech continuation state, a return is made to the end point wait state if the state where Δθ(n)>θth and P(n)≦Pth1 is reached within T1 or the maximum value of P(n) is below Pth until the state where Δθ(n)>θth and P(n)≦Pth1 is reached; otherwise, a transition is made to the speech continuation state representing that speech is continuing.

In the speech continuation state, a transition is made to the end point wait state when the state where Δθ(n)>θth and P(n)≦Pth1 is reached.

The method (2) takes an interval which, of the speech intervals obtained in accordance with the above-described procedure, satisfies P(n)>Pth2 as a speech interval. Here, Pth2 is the second threshold of P(n) as described previously.

With method (2), setting Pth and Pth2 large may fail to detect a speech interval where the S/N ratio is low. It is therefore only required that Pth1 and Pth2 be set smaller than in the case of detection based on signal power only. Even with Pth and Pth2 set small, since the value for the direction of a target source is used on priority basis, the speech detecting capability can be enhanced with certainty. For example, Pth, Pth1 and Pth2 may be set to Pth=5 dB, Pth1=2 dB and Pth2=5 dB, which are values relative to the background noise level. It is advisable to determine the values for Pth, Pth1 and Pth2 experimentally according to background noise conditions.

This embodiment, which detects the direction of a target speech source from filter coefficients of a filter in the beam former rather than suppresses noise with the beam former, allows a speech interval of a target speech source to be detected accurately even in an environment in which the direction of a noise source cannot be identified.

Next, a second embodiment of the present invention will be described. In the block diagrams used for description of the following embodiments, identically termed blocks have basically the same function and hence detailed descriptions thereof are omitted.

The second embodiment, which is intended to find the direction of a target speech source with high accuracy even in the presence of a noise source in some direction, will be described in terms of an example of causing the beam former that suppresses a signal from the target speech source to follow the direction of the noise source.

In order to make the direction of a noise source set by the beam former follow the direction of an actual noise source, the second embodiment is provided with a second beam former in addition to a first beam former adapted to suppress a signal coming from a target speech source. The direction of the noise source is estimated based on the directivity of a filter in the second beam former and the first beam former is controlled accordingly.

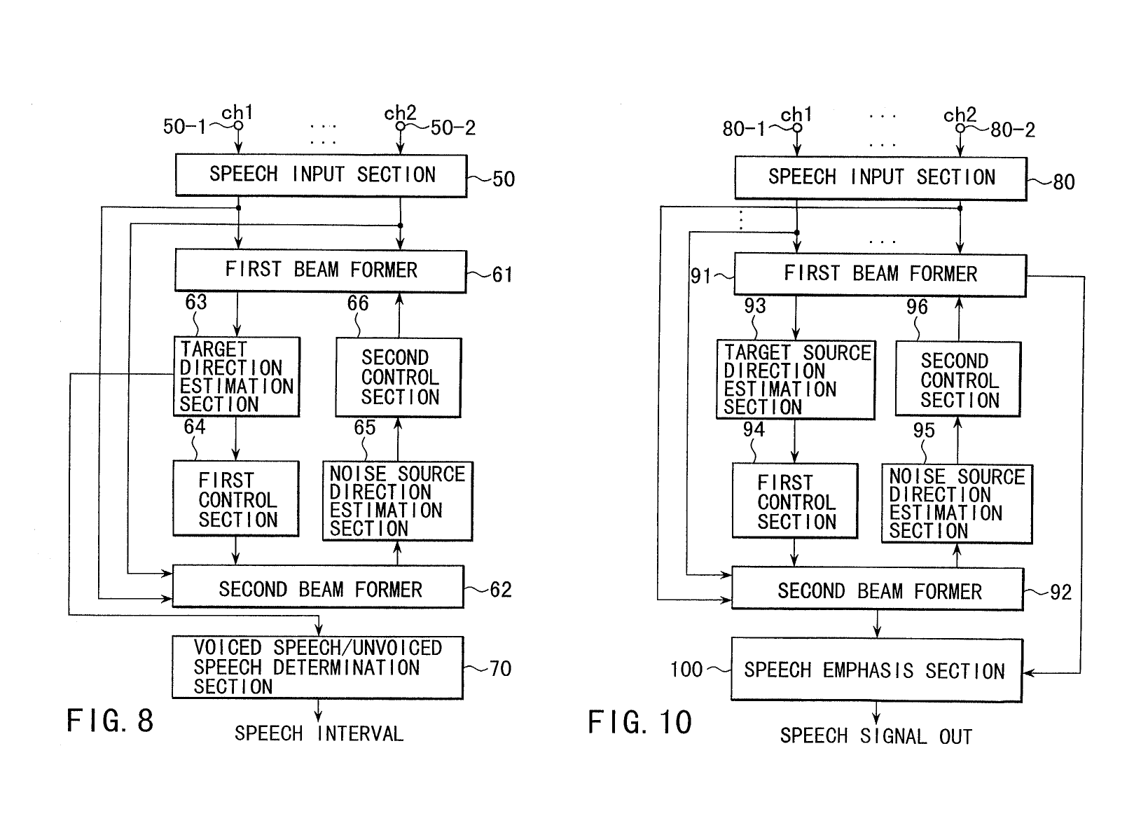

FIG. 8 shows an arrangement of a speech processing apparatus having a speech interval detecting function according to the second embodiment. In the second embodiment, the number of channels is two. This is only for simplicity and not restrictive.

A speech signal is entered into a speech input section 50 through input terminals 50-1 and 50-2 associated with channels ch1 and ch2 and then into first and second beam formers 61 and 62. A target direction estimation section 63 estimates the direction of a target speech source from filter coefficients of the filter in the first beam former 61 and provides the result to a first controller 64. A noise source direction estimation section 65 estimates the direction of a noise source from the filter coefficients of a filter in the second beam former 62 and provides the result to a second controller 66.

A voiced/unvoiced speech determination section 70 makes a voiced/unvoiced speech determination on the basis of at least one of time series of target speech direction estimated by the target speech direction estimation section 70, time series for the signal power obtained from the speech input section 50, and time series for the interchannel signal correlation obtained from the speech input section 50. In the following description, the directions of the noise source and the speech source set in the first and second beam formers are each referred to as the input direction.

The first controller 64 controls the second beam former 62 so that the direction of the target source estimated by the direction estimation section 63 will be set as its input direction. The second controller 66 controls the first beam former 61 so that the direction of the noise source estimated by the direction estimation section 65 will be set as its input direction. Setting the direction of noise source as the input direction of the first beam former 61 is intended to disable the first beam former from estimating the direction of the noise source. Likewise, setting the direction of target source as the input direction of the second beam former 62 is intended to disable the second beam former from estimating the direction of the target source.

The first and second beam formers 61 and 62 may be either the GSC, of the frost type, or of the reference signal type as described previously. The first beam former filter is set such that its sensitivity is low in the direction of the target source, while the second beam former filter is set such that its sensitivity is low in the direction of the noise source. The direction of the target source or noise source can be estimated by examining the directivity representing the dependence of filter sensitivity on direction on the basis of the filter coefficients.

The direction estimation sections 63 and 65 perform the procedure shown in FIG. 4 to estimate the directions of the target source and the noise source on the basis of the directivity of the filters in the first and second beam formers 61 and 62. It is assumed here that, at initialization time, the range of search by the first beam former 61 for the direction of a target source is set at 20° and the range of search by the second beam former 62 for the direction of a noise source is set at 90°.

Each of the controllers 64 and 65 weights each estimated direction of the source by an output power of the corresponding beam former and averages the source directions estimated so far, thereby updating the input direction. The calculations may be performed in accordance with arithmetic operations disclosed in Japanese Patent Application No. 9-9794 by way of example. Thus, updating control can be performed in such a way that updating is performed fast when the power of a signal from the target source is high and the noise power is low or slow in the other situations.

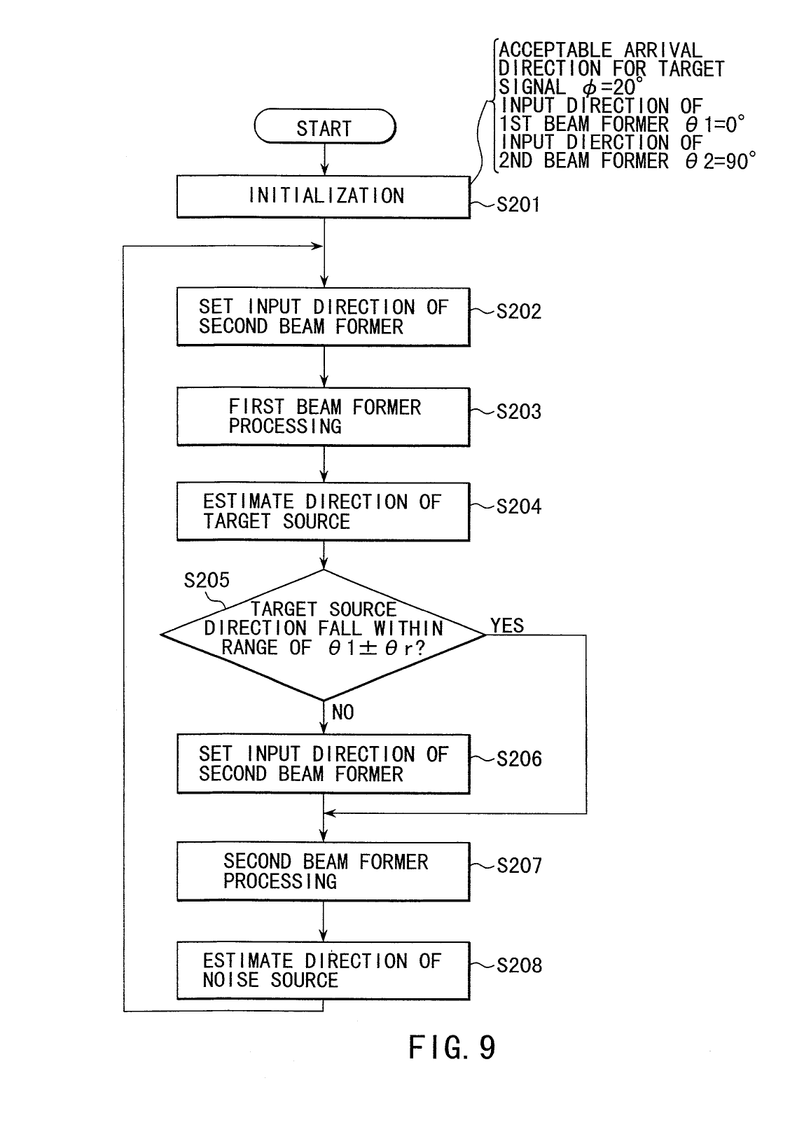

FIG. 9 shows the overall process flow of the second embodiment including the above-described estimation process. First, in initialization step S201, an allowable range Φ is set as the direction of a target source, the input direction θ1 of the first beam former is set to 0°, the input direction θ2 of the second beam former is set to 90°, the search range θr1 of the target source direction estimation section 63 is set to 20°, and the search range θr2 of the noise source direction estimation section 65 is set to 90°. Here, in order to consider a signal that arrives from within a certain range of angles as a signal from a target source, an allowable range Φ is set up for the direction of a target source, which is set equal to, for example, the search range of the first beam former 61, i.e., Φ=θr1=20°. The direction is referenced to the direction (0°) perpendicular to the line connecting the two microphones as shown in FIG. 5. That is, the angle is measured in relation to a normal to that line.

Next, the input direction of the first beam former 61 is set (step S202). The input direction is set here so that signals from the set input direction can be considered to have arrived at the microphone array at the same time by introducing a time difference between the two-channel signals. The time delay introduced into a signal on the first channel ch1 by the delay element 26 shown in FIG. 3 is calculated by τ=d sin(θ1)/c where c is the velocity of sound and d is the distance between the microphones.

Next, the processing associated with the first beam former 61 is performed (step S203) and the direction of a target source is estimated from the resulting filter coefficients in accordance with the above-described method (step S204). The estimated direction of the target source is assumed to be θn.

Next, a decision is made as to whether or not the direction θn of the target source estimated in step S204 is in the vicinity of the direction of the noise source (0°±Φ) (step S205). If it is so, then the procedure goes to step S207.

If it is not so, the input direction of the second beam former 62 is set so that the estimated direction of the target source becomes the input direction (step S206). That is, the θ2 value is updated by the previously mentioned averaging. As in step S202, in the second beam former 62, the time delay imparted to the first channel ch1 by the delay element 26 of FIG. 3 is calculated by τ=d sin(θ2)/c so that signals from the input direction can be considered to have arrived at the microphone array at the same time.

Next, the processing associated with the second beam former 62 is performed (step S207) and the direction of the noise source is estimated within the search range ±θr2 (step S208). The procedure again returns to step S202 to set the input direction of the first beam former 61 so that the estimated direction of the noise source will be taken as the input direction. In this case as well, the input direction is updated by the previously mentioned averaging. After that, the above-described processing is repeated.

The voiced/unvoiced speech determination section 70 makes a voiced/unvoiced speech determination in accordance with the procedure shown in FIG. 6 or FIG. 7. As the specific determination method, use may be made of the two methods described in connection with the first embodiment.

According to the second embodiment, a speech interval of a target source can be detected accurately even in the presence of a noise source in some direction because there are provided two beam formers: one for estimating the direction of a target source, and one for estimating the direction of a noise source.

Next, a third embodiment of the present invention will be described, which, using the two-beam-former arrangement as in the first embodiment, performs speech enhancement rather than detects a speech interval and extracts a target speech signal with high accuracy. The arrangement of the third embodiment is shown in FIG. 10.

A speech signal processing apparatus of FIG. 10 comprises a speech input section 80 for receiving speech signals sent over multiple channels, a first beam former 91 for filtering input speech signals to suppress a signal from a target source, a second beam former 92 for filtering input speech signals to suppress noise and extract the signal from the target source, a target source direction estimation section 93 for estimating the direction of the target source from filter coefficients of a filter in the first beam former 91, a first controller 94 for setting the target source direction estimated by the target source direction estimation section as the target direction of the second beam former 92, a noise source direction estimation section 95 for estimating the direction of a noise source from filter coefficients of a filter in the second beam former 92, a second controller 96 for setting the estimated noise source direction as the target direction of the first beam former, and a speech enhancement section 100 for suppressing noise components in the output signal of the second beam former 92 to enhance a speech signal.

This arrangement is distinct from the arrangement of the second embodiment shown in FIG. 8 in that the speech enhancement section 100 is used in place of the voiced/unvoiced speech determination section 70 and the output signal of the second beam former 91, while being not used in the second embodiment, is used as a noise reference signal for speech enhancement.

As described previously, the noise suppression capability of the beam former is degraded in an environment in which there are so many noise sources that their directions cannot be identified. However, the beam former whose input direction has been set to the direction of a noise source can extract only noise outputs while suppressing a signal from a target source. This is because the direction of a target speech source differs from the noise source direction. Thus, the output signal of the beam former 91 will contain only noise. This can be used to enhance speech through a conventionally known spectral subtraction scheme. The spectral subtraction is described in detail in literature 4: “Suppression of acoustics noise in speech using spectral subtraction” by S. Boll, IEEE trans., ASSP-27, No. 2, pp. 113-120, 1979.

The spectral subtraction methods include the 2-channel method that uses two channels for a reference noise signal and a speech signal and the 1-channel method that uses one channel for a speech signal. The third embodiment performs speech enhancement by the 2-channel spectral subtraction that uses the output of the beam former 91 as a reference noise signal. In general, as a noise signal for the 2-channel spectral subtraction use is made of a signal from a noise pickup microphone spaced away from a target speech pickup microphone. In this case, however, the resulting noise signal will be different in property from noise picked up by the speech microphone, which will result in a problem that the accuracy of spectral subtraction decreases.

In contrast, the third embodiment does not use a microphone dedicated to pickup of noise and extracts a noise signal from a signal produced by a speech pickup microphone, thus making it possible to perform the spectral subtraction with accuracy. The third embodiment is distinct from the second embodiment only in the 2-channel spectral subtraction. Thus, the 2-channel spectral subtraction will be described first.

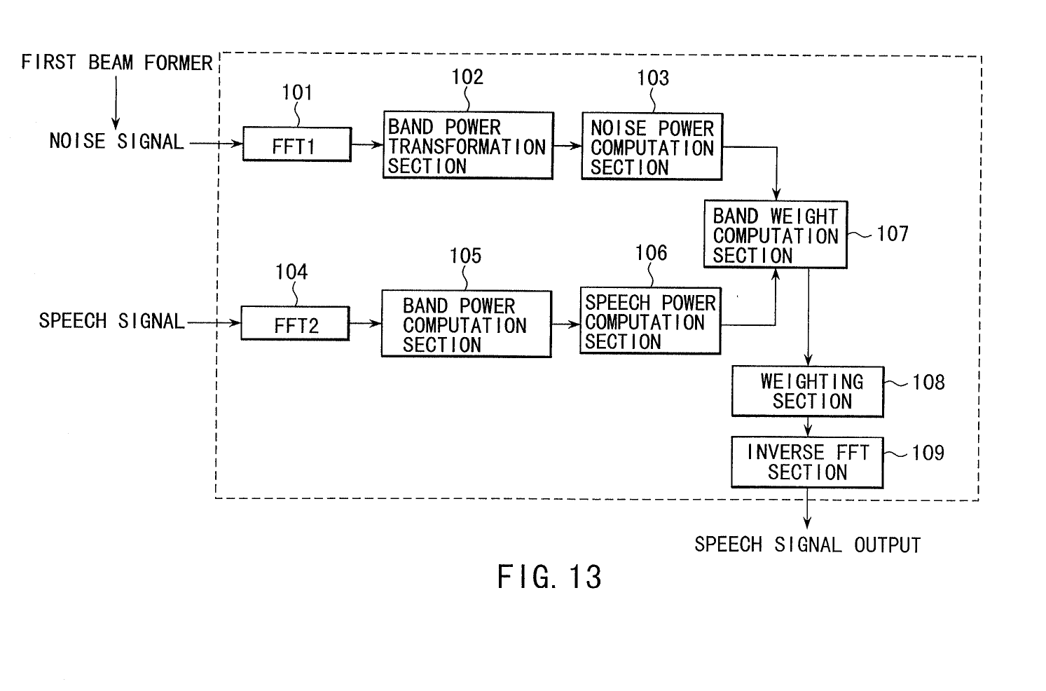

The 2-channel spectral subtraction section is arranged as depicted in FIG. 13. Input data is divided into blocks and the spectral subtraction is performed on a block-by-block basis. The section includes a first FFT section 101 for Fourier transforming a noise signal, a first band power converter 102 for converting frequency components obtained by the first FFT into band powers, a noise power computation section 103 for time averaging the resulting band powers, a second FFT section 104 for Fourier transforming a speech signal, a second band power converter 105 for converting frequency components obtained by the second FFT into band powers, a speech power computation section 106 for time averaging the resulting band powers, a band weight computation section 107 for computing the weight of each band from the noise powers and speech powers, a weighting section 108 for weighting each of frequency spectra obtained by the second FFT from the speech signal with a corresponding weight, and an inverse FFT section 109 for subjecting the weighted frequency spectra to inverse FFT to output speech.

The block length is assumed to be 256 points, equal to the number of points in the FFT process. In the FFT process, the frequency spectrum is subjected to windowing through the use of a Hanning window and the same processing is repeated while shifting 128 points corresponding to half the block length. Finally, the waveforms obtained by the inverse FFT are added with overlap of 128 points between each waveform and the next waveform. This provides recovery from distortion due to windowing.

For conversion into band power, the frequency spectrum is divided into 16 bands as indicated in Table 1 and the sum of squares of frequency components within each band is computed to yield the band power.

The noise power and the speech power are computed for each band through a first-order recursive filter, as follows:

p k,n=a·ppk+(1−a)·p k,n−1 (5)

v k,n=a·vvk+(1−a)·v k,n−1 (6)

where k is the band number, n is the block number, p is the average noise band power, pp is the noise band power of the block in question, v is the average speech band power, vv is the speech band power of the block in question, and a is a constant. The value for a is selected to be, for example, 0.5.

The band weight computation section uses the obtained noise and speech band powers to compute the weight wk,n for each band as follows:

wk,n=|vk,n−pk,n|/vk,n (7)

Using the weight for each band, a speech frequency component is weighted as follows:

Yi,n=Xi,n·wk,n (8)

where Yi,n is a weighted frequency component, Xi,n is a speech frequency component obtained by the second FFT process, and i is the frequency component number.

In Table 1, weight wk,n for band k corresponding to frequency band number i is used.

TABLE 1

FREQUENCY COMPONENT
NUMBER

| BAND NUMBER | LOWER LIMIT | UPPER LIMIT |
|---|---|---|
| 1 | 1 | 8 |
| 2 | 8 | 16 |
| 3 | 16 | 24 |
| 4 | 24 | 32 |
| 5 | 32 | 40 |
| 6 | 40 | 48 |
| 7 | 48 | 56 |
| 8 | 56 | 64 |
| 9 | 64 | 72 |
| 10 | 72 | 80 |
| 11 | 80 | 88 |
| 12 | 88 | 96 |
| 13 | 96 | 104 |
| 14 | 104 | 112 |
| 15 | 112 | 120 |
| 16 | 120 | 128 |

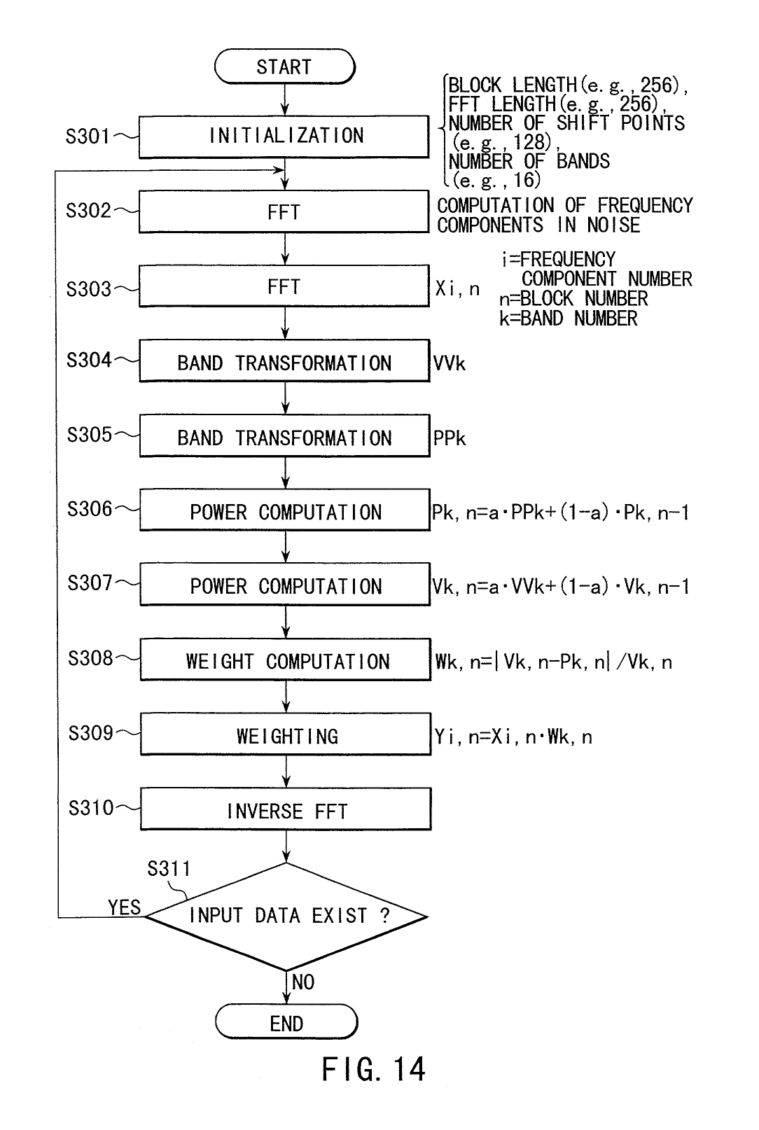

The process flow by the 2-channel speech enhancement section will be described with reference to FIG. 14.

First, initialization is performed such that block length=256, number of FFT points=256, number of shift points=128, and number of blocks=16 (step S301). In the first FFT section, noise-channel data is subjected to windowing and FFT to obtain frequency components associated with noise (step S302). In the second FFT section, speech-channel data is subjected to windowing and FFT to obtain frequency components associated with speech (step S303). In the first band power conversion section, noise band powers are computed from the noise frequency components in accordance with the band-to-frequency component allocation indicated in Table 1 (step S304). In the second band conversion section, speech band powers are likewise computed from the speech frequency components (step S305). In the noise power computation section, the average noise power is computed in accordance with expression (5) (step S306). In the speech power computation section, the average speech power is computed in accordance with expression (6) (step S307). In the band weight computation section, the weight of each band is computed in accordance with expression (7) (step S308). In the weighting section, the speech frequency components are weighted (multiplied) by the weighting coefficients obtained in step S308 in accordance with expression (8) (step S309). In the inverse FFT section, the weighted frequency components are subjected to inverse FFT to obtain a waveform, which is in turn superimposed on the last 128 points of the waveform obtained through the previous block (step S310).

Steps S302 through S310 are repeated until input data is exhausted.

The above-described processing is conveniently performed on a block-by-block basis in synchronism with the overall processing including the beam former processing. In this case, the block length in the beam former needs to match 128 points by which a shift is made in the speech enhancement section.

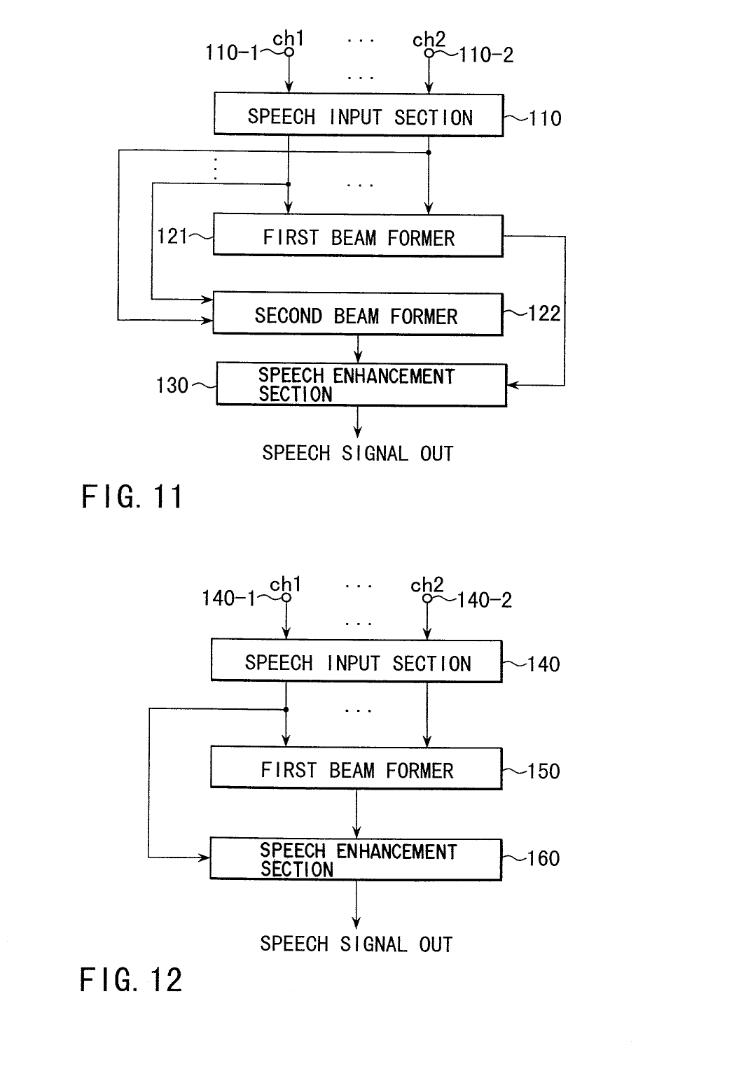

FIG. 11 shows a speech processing apparatus according to a fourth embodiment of the present invention.

In the third embodiment, the two beam formers are controlled so that they are directed to a noise source and a target speech source, respectively. If the speech source and the noise source are fixed in position and their directions are known, then controlling of the beam formers in that manner will not be required. Thus, the target speech source direction estimation section 93 and the first and second controllers 94 and 96 may be omitted as in the fourth embodiment. In this case, the first beam former 121 is directed to the intensest noise source and the second beam former 122 is directed to the target speech source. The processing can be carried out easily without the source direction estimation sections and the direction controllers in the second embodiment and hence further description will not be required.

FIG. 12 shows a speech processing apparatus having a speech enhancement function according to a fifth embodiment of the present invention. In the absence of any noise source intenser than a target speech source, the second beam former that suppresses noise may be omitted as in the fifth embodiment. In this case as well, since the processing by the second beam former is merely omitted, further description will not be required.

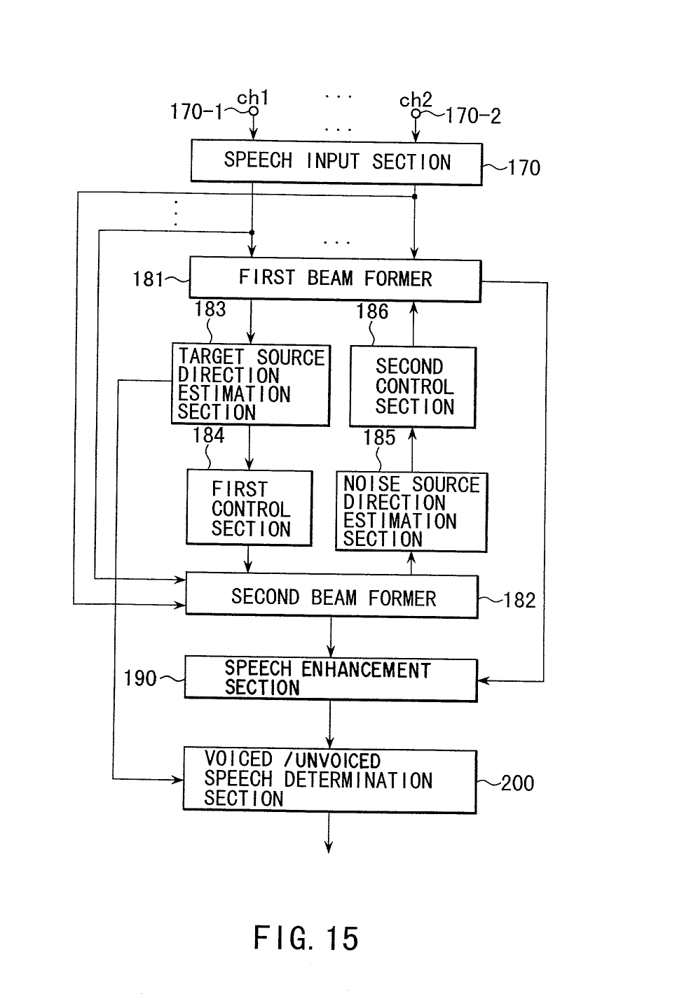

FIG. 15 shows an arrangement of a speech processing apparatus with a speech interval detecting function according to a sixth embodiment. The second embodiment was described in terms of an example of improving the speech interval detecting capability in a noisy environment by using the direction of a target speech source obtained by the filter in the first beam former that suppresses a signal from the target speech source for detecting a speech interval. The sixth embodiment is intended to further improve the speech interval detecting capability by using the target source direction and the output of the speech enhancement section described in the third embodiment in combination.

As shown in FIG. 15, the sixth embodiment is arranged such that the voiced/unvoiced speech determination section 70 used in the second embodiment is added to the arrangement of the third embodiment and has a feature that the output of the speech enhancement section is used for speech interval detection processing instead of using the output of the second beam former used in the second embodiment.

The speech enhancement based on two-channel spectral subtraction using the output of the first beam former that suppresses a signal from a target speech source as a noise signal allows noise to be suppressed more accurately than the conventional two-channel spectral subtraction. Moreover, the speech interval detection based on the speech enhanced output and the target speech source direction allows the speech interval detecting capability in a nonsteady noise environment to be improved significantly.

Parameters used to detect a speech interval include not only beam former output power and target source direction but also the number of zero crossings, spectrum tilt, LPC cepstral coefficients, Δ-cepstral coefficients, Δ2-cepstral coefficients, LPC residues, autocorrelation coefficients, reflection coefficients, logarithmic area ratios, and pitches. These parameters may be used in combination as needed.

As described above, according to the present invention, a speech interval of a target speech source can be detected accurately in such an environment as the S/N ratio is so low that the direction of a noise source cannot be identified. Additionally, speech enhancement can be performed.

Hereinafter, description will be given of a signal processing apparatus and method which may track a direction from which a signal arrives with a simple arrangement without using space search processing that involves a large amount of computation and hence may extract a target signal accurately with a small amount of computation without target signal cancellation.

A seventh embodiment is intended to track the arrival direction of a signal on the basis of outputs of multiple beam formers which have their respective input directions set different. For better understanding, two-beam-former-based tracking processing in two-dimensional space will be described on the assumption that a signal arrives from a direction in a horizontal plane. The direction tracking processing in three-dimensional space using three beam formers will be described as an eighth embodiment. In the case of four or more beam formers, expansion is likewise feasible.

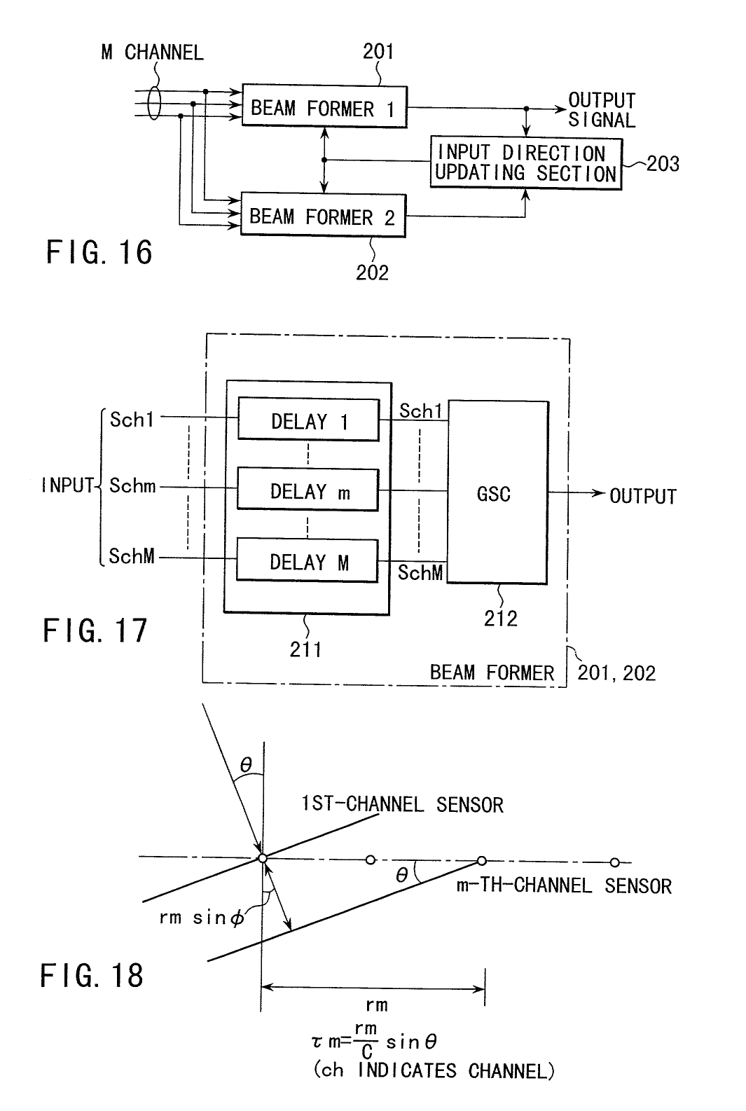

In FIG. 16, there is illustrated an arrangement for tracking the arrival direction of a signal on the basis of outputs of multiple beam formers having their respective input directions set different. In FIG. 17, Sch1, Sch2, Sch3, . . . , SchM denote input signals on first (ch1) to M-th channels (chM). These channel signals are obtained from corresponding acoustic electric transducers (hereinafter called sensors) of a microphone array (not shown) in which M such transducers are arranged, for example, in a line. Each sensor should preferably be a directional one for the purpose of obtaining high accuracy, but it may be nondirectional.

In FIG. 16, the first beam former 201 is an input direction variable type of beam former which performs filter operations on the multi-channel input signals Sch1, Sch2, Sch3, . . . , SchM to suppress noise by suppressing components outside its previously set input direction and, upon receipt of updating information addressed it, updates the input direction accordingly. The second beam former 202 is also of an input direction variable type which functions identically to the first beam former except that its input direction is set different from that of the first beam former. An input direction update section 3 is responsive to output powers of the first and second beam formers 201 and 202 to make a decision of which of the input directions set for the first and second beam formers the signal arrival direction is closer to and seek input direction correction quantities to obtain new input directions for the first and second beam formers. This information is applied to the first and second beam formers as the updating information.

In this apparatus, the input signals Sch1 to SchM are applied to each of the first and second beam formers 201 and 202, and the output signal of the first beam former is used as a final output signal of the apparatus.

As the beam former processing, use may be made of various methods as described previously. The present invention is beam former processing-independent. Fixed beam former processing, such as addition of delayed signals, may be used. Here, the Gliffith-Jim sidelobe canceller (GSC), one of standard beam formers, described in the previously described literature 2 is taken as an example.

When the GSC is used, the first and second beam formers are each arranged as shown in FIG. 17.

In FIG. 17, an input direction update section 211, which introduces a time delay in each of input signals on channels, is connected to a GSC 212. The setting of an input direction of the beam former is performed by introducing a time delay in each of the input signals.

The delay time τm to be introduced in the m-th channel signal Schm can be computed from the input direction set in the beam former. That is, as shown in FIG. 18, the delay time τm is given by

τm=(rm sin θ)/c (9)

where rm is the distance of the m-th channel sensor from the 1-st sensor in a linear array, θ is the input direction of the beam former with respect to a normal to the array, and c is the velocity of sound. Note that the delay time τ1 for the 1-st channel signal is set to zero.

Thus, the time delays involved when a signal arrives from a direction of θ are compensated for, which allows multi-channel signals to be considered to have been arrived from a direction of 0°.

A method of introducing a delay in a signal, as described in the previously mentioned literature 1 “Acoustic System and Digital Processing” (p. 215), is to implement a digital filter by shifting a Sinc function on the time axis and subjecting it to windowing and then convolve the m-th channel signal with the digital filter coefficients.

Depending on the beam former processing system, no delay elements are needed to set an input direction. However, the use of delay elements is favorable from a computational viewpoint.

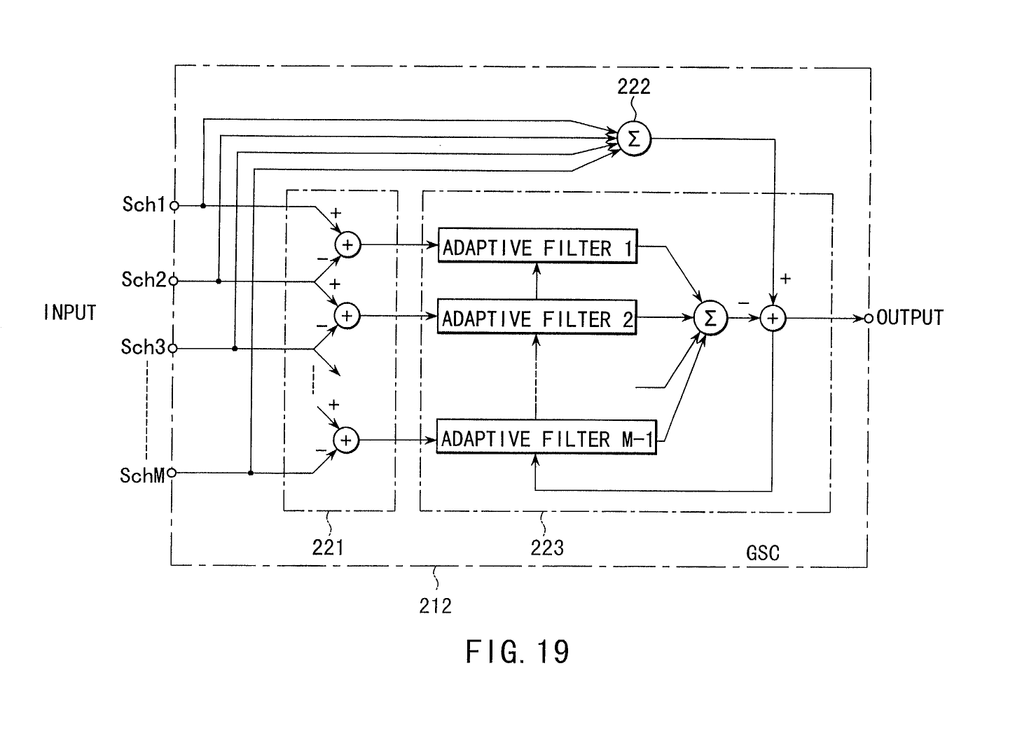

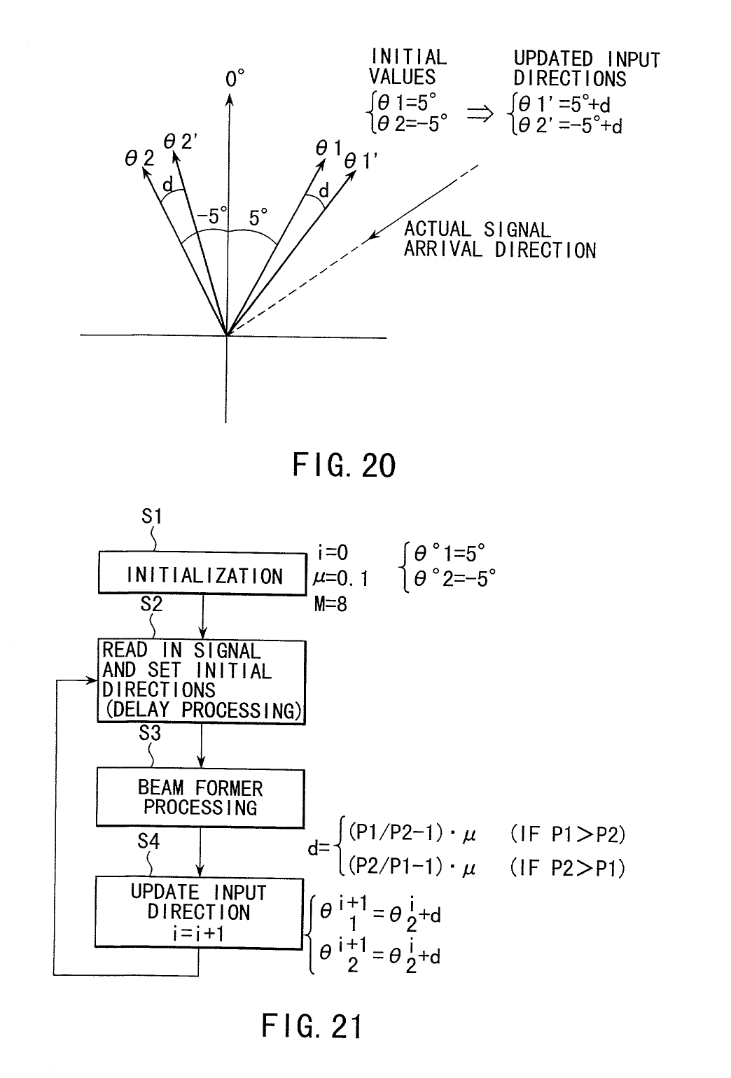

The Griffith-Jim type GSC 212 is arranged as depicted in FIG. 19. Sch1, Sch2, Sch3, . . . , Schm denote 1-st- to m-th-channel input signals, respectively.

The GSC comprises, as shown in FIG. 19, a blocking filter 121 which produces differentials between signals on adjacent channels to obtain a (M−1) number of differential signals, an adder 222 that sums the M-channel input signals Sch1 to SchM, and an M−1-channel input adaptive filter section 223 which receives the (M−1)-channel differential signals from the blocking filter 221 as a reference signal and the output of the adder 222 as its target response.

The processing by the GSC is described in detail in the previously mentioned literature 2 and a description thereof is thus omitted here.

In the present system, in the beam formers 201 and 202, the delay section 211 is used to delay each of the input signals Sch1 to SchM by a desired amount of time, which permits the input direction of each beam former to be set as desired. Thus, the delay sections 211 of the beam formers 201 and 202 are initialized so that the first and second beam formers will have desired but different input directions set.

In order to attain the object of the invention, it is only required that there be some difference in input direction between the first and second beam formers. The degree of difference may be set arbitrarily. From ease of control, it is recommended that the initial values θ⁰1 and θ⁰2 of the input directions θ1 and θ2 of the first and second beam formers be slightly different, say, +5° and −5°.

Using the outputs of these two beam formers 201 and 202, the input direction update section 203 detects which of the input directions of the beam formers is closer to the actual signal arrival direction. This detection can be made by making a comparison between output powers of the beam formers 202 and 202. It can be supposed that the input direction set for the beam former that is larger in output power is closer to the actual signal arrival direction. The reason is that, if the input direction set for a beam former matches the actual signal arrival direction, then the incoming signal is output as it is to provide a high output power, but the beam former output power reduces sharply as the input direction deviates farther from the actual signal arrival direction since the incoming signal is considered as noise and removed as a result.

In practice, in order to compute an input direction for beam former processing for new input data, the input direction update section 203 first computes a variation d of the input direction as follows:

with P1>P2

d=(p1/p2−1.0)*μ (10)

with P2>P1

d=−(p2/p1−1.0)*μ (11)

where p1 is the output power of the first beam former 201, p2 is the output power of the second beam former 202, and μ is a step size of 0.1 for example.

This means that, when d is positive, the actual signal arrival direction is closer to the input direction of the first beam former, whereas, when d is negative, the actual signal arrival direction is closer to the input direction of the second beam former.

The variation d may be computed as follows:

d=α (if p1>p2)

d=−α (if p2>p1)

where α is a constant of 0.1 for example.

Assuming i to be the number of updates, the new input directions θⁱ⁺¹₁, θⁱ⁺¹₂ are updated by the (i+1)st update operation as follows:

θⁱ⁺¹₁=θⁱ₁+d (12)

θⁱ⁺¹₂=θⁱ₂+d (13)

By updating the input directions set for the beam formers in that manner, the input direction will approach the actual arrival direction. By performing this updating at regular intervals of, for example, 10 ms, the input direction will be allowed to gradually approach the actual signal arrival direction. Even if the arrival direction is changed, it can be tracked.

The flow of beam former processing of the present embodiment will be described with reference to FIG. 21. The input direction update processing is performed regularly at intervals of a period and the data length corresponding to that period is taken as one block for block-by-block processing. Assuming the sampling frequency to be 11 kHz, the block length is set to 100 samples per channel.

The procedure will be described mainly for the input direction update processing by the input direction update section 203, as follows:

First, the initialization is performed to set the input direction updating step size to μ=0.1, the number of channels to M=8, the initial value θ⁰1 of the input direction of the first beam former 201 to 5°, the initial value θ⁰2 of the input direction of the first beam former 202 to −5°, the filter coefficients of the beam formers all to 0s, and the number of input direction updates to i=0 (step S1). In the beam formers 201 and 202, input data is read in and then input signals of one block length are delayed on the basis of the input directions θⁱ₁ and θⁱ₂ after the i-th update operation (step S2). After that, the beam former processing including adaptive filter operations is performed on the delayed input signals (step S3). In the input direction update section 203, the output powers P1 and P2 of the beam formers 201 and 202 are computed as the sums of squares of output signals of the respective beam formers. After that, the input direction of each of the beam formers is updated in accordance with expressions (10), (11), (12) and (13) and the number of input direction updates is incremented to i+1 (step S4). The procedure then returns to step S2.

The input direction update section 203 continues updating the input directions while repeating the above processes until input data is exhausted.

By reestablishing the input directions of the beam formers by furnishing the updated input directions to their respective delay sections 211, the input directions are made to approach the actual signal arrival direction. Therefore, repeating this processing at regular intervals of a time of, for example, 10 ms allows the input direction of each beam former to gradually approach the real signal arrival direction. In addition, even if the signal arrival direction shifts, it can be tracked.

As described above, the seventh embodiment, which is directed to a signal processing apparatus which performs beam-former-based adaptive filter operations on input signals from transducers in a microphone array in which multiple acoustic-electric transducers (sensors) are arranged in a specific configuration and extracts a signal arriving from a target direction as an output signal while suppressing noise, allows the direction from which a signal arrives to be tracked with a straightforward arrangement without using computation-intensive spatial searching and allows a target signal to be extracted accurately though a required amount of computation is small. This owes to the provision of a pair of beam formers: one for extracting an output signal, and one for referencing, the paired beam formers being arranged such that their respective input directions are variable and set slightly different at initialization time, and an input direction update section which examines output powers of the respective beam formers to compute a quantity of correction of the input directions in accordance with the higher one, computes new input directions corrected by the quantity of correction as updating information, updates the beam former input directions in accordance with the updating information, and repeats this update processing.

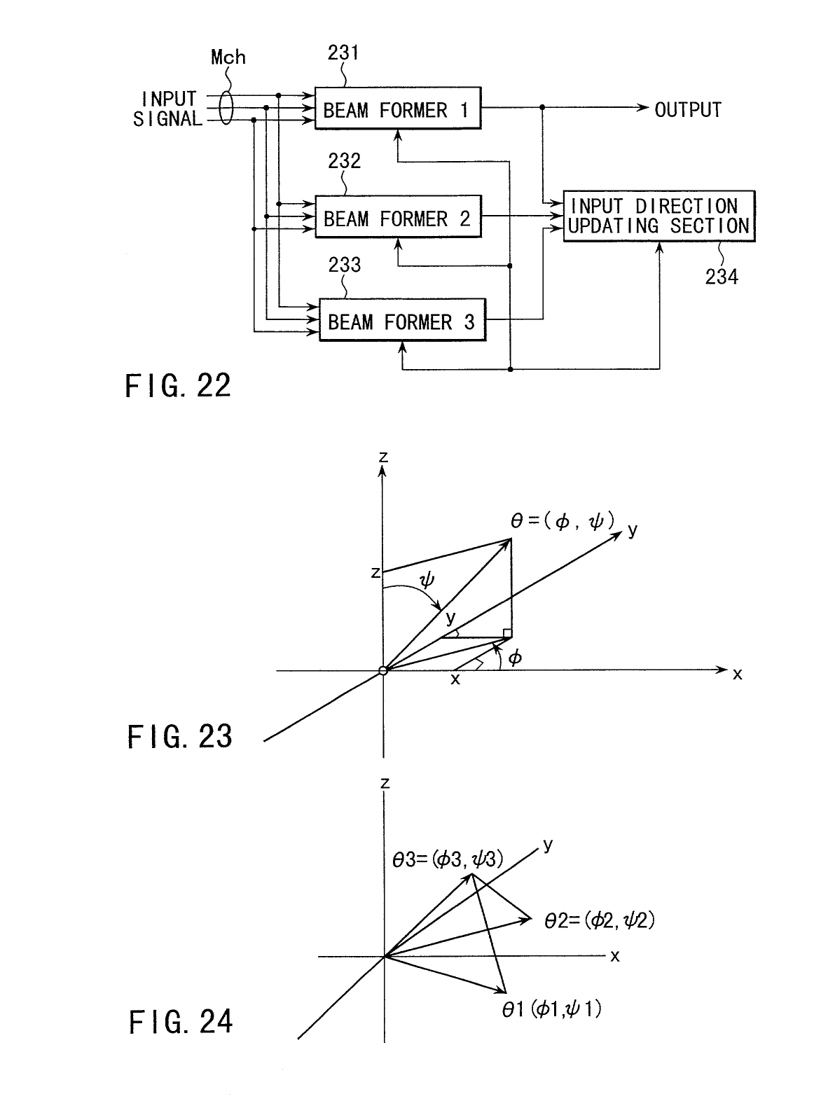

The seventh embodiment is directed to processing using two beam formers having their respectively input directions set differently on the assumption that a signal arrives from a certain direction in a horizontal plane. The use of three beam formers having their respective input directions set different will allow a signal arrival direction to be tracked and a target signal to be extracted even in the case where it arrives from any direction in three-dimensional space. An embodiment using three such beam formers will be described next with reference to FIG. 22.

In FIG. 22, a first beam former 231 performs filtering operations on multi-channel input signals to suppress noise. A second beam former 232 performs filtering operations on the input signals with its input direction set different from that of the first beam former. A third beam former 233 performs filtering operations on the input signals with its input direction set different from those of the first and second beam formers. An input direction update section 234 is responsive to output powers of the first, second and third beam formers to make a decision of which of the input directions of the beam formers an actual signal arrival direction is closer to and updates their input directions accordingly.

In the present apparatus, the input signals Sch1 to SchM are applied to the first, second and third beam formers 231, 232 and 233 and an output signal of the first beam former is used as a final output signal of the apparatus.

In this embodiment, the first and second beam formers 231 and 232 are basically the same as the first and second beam formers 201 and 202 in the first embodiment. The present embodiment is distinct from the first embodiment in the ways of computation of delay amounts, of setting the input direction of the third beam former 33, and of computation for input direction updating. These different points will be described below.

As shown in FIG. 23, let a direction θ in three-dimensional space be represented by a vector having two angle components such that θ=(φ, ψ). As shown in FIG. 24, let the input direction vectors of the three beam formers be represented by θ1, θ2 and θ3, respectively. In order for the three vectors not to align, for example, their initial values θ⁰1, θ⁰2 and θ⁰3 are set as follows:

θ⁰₁=(−5°, 90°) (14)

θ⁰₂=(5°, 90°) (15)

θ⁰₃=(0°, 85°) (16)

From FIG. 23, the coordinates (X, y, z) in the orthogonal coordinate system and the angle ψ are related by

X=sin(ψ)cos(φ) (17)

y=sin(ψ)cos(φ) (18)

z=cos(φ) (19)

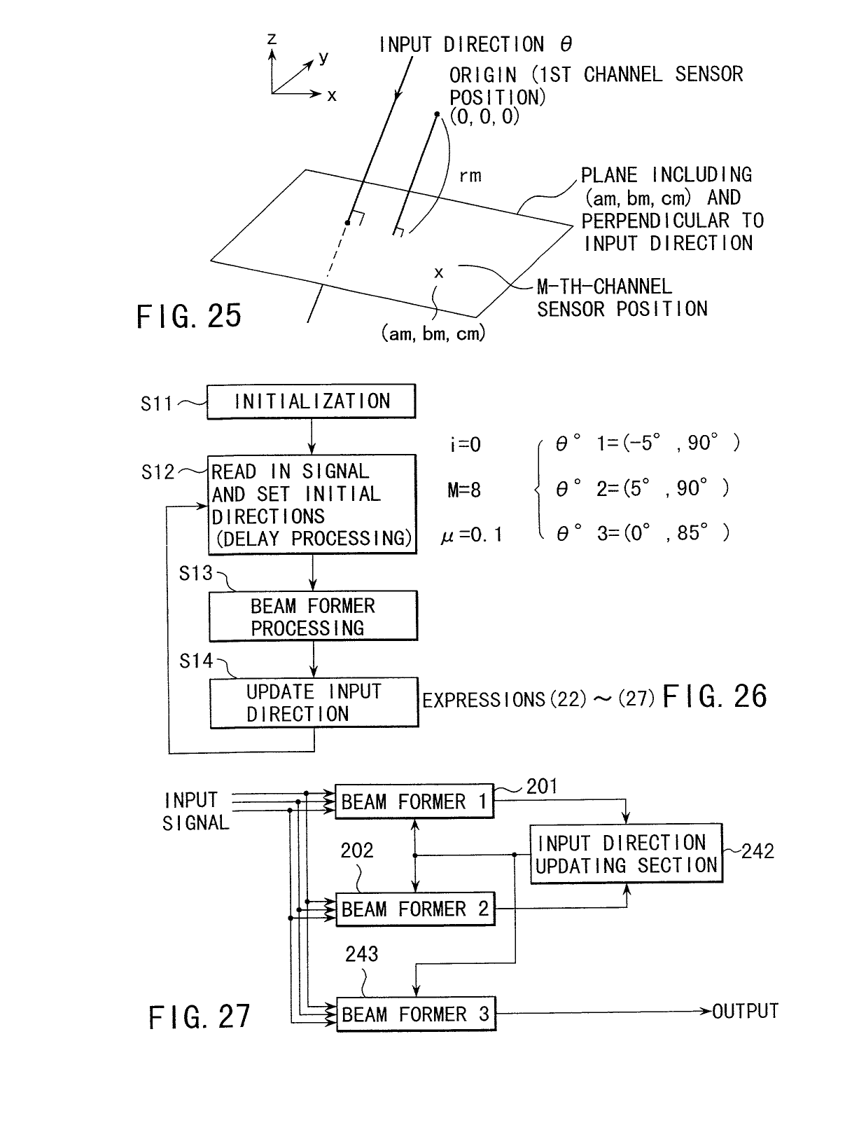

Assuming that, as shown in FIG. 25, the first-channel sensor is located at origin (0, 0, 0) and the distance between the origin and the plane which includes the m-th-channel sensor placed at location (am, bm, cm) is rm, the amount of delay to be given to a signal to set the direction of vector θas the beam former input direction is given by

rm=−rm/v (20)

Applying the well-known equation to find the distance between a point and a plane to the distance, rm, between the origin and the plane including the m-channel sensor yields

rm=|xaₘ+ybₘ+zcₘ|/(x²+y²+z²)^{½} (21)

Thus, Tm is sought by substituting expressions (21), (17), (18) and (19) into expression (20). Here, v is the velocity of sound.

For updating the input direction of the beam former, the input direction update section 34 computes the output powers p1, p2 and p3 of the three beam formers and seeks a variation vector d as follows:

If p1 is a maximum,

d=(p1/(p2+p3)/2)·1.0)*μ*θⁱ₁ (22)

If p2 is a maximum,

d=(p2/(p1+p3)/2)·1.0)*μ*θⁱ₂ (23)

If p3 is a maximum,

d=(p3/(p1+p3)/2)·1.0)*μ*θⁱ₃ (24)

However, it is also possible to compute d using a fixed value α, as follows:

If p1 is a maximum,

d=α·θⁱ₁

If p2 is a maximum,

d=α·θⁱ₂

If p3 is a maximum,

d=α·θⁱ₃

where θⁱ1, θⁱ2 and θⁱ3 are input direction vectors of the three beam formers after the i-th updating.

The (i+1)st updating is performed as follows:

θⁱ⁺¹₁=θⁱ₁+d (25)

θⁱ⁺¹₂=θⁱ₂+d (26)

θⁱ⁺¹₃=θⁱ₃+d (27)

The beam formers are set to the new input directions thus obtained. Repeating this processing allows a signal to be tracked in three-dimensional space.

The overall process flow of the embodiment will be described with reference to FIG. 26. As in the seventh embodiment, the input direction updating by the input direction update section 234 is performed regularly at intervals of a period. The block-by-block processing is performed with a data length corresponding to this period taken as one block length. For example, one block length is set to 50 samples per channel in the case where the sampling frequency is 11 kHz.

First, the initialization is performed to set the input direction updating step size μ, the number of channels M, the initial values θ⁰₁, θ⁰₂ and θ⁰₃ of the input directions of the first, second and third beam formers 231, 232 and 233, the filter coefficients of the beam formers all to 0s, and the number of input direction updatings to i=0 (step S11). In the beam formers 231, 232 and 233, input data is read in and then input signals of one block length are delayed on the basis of the input directions θⁱ₁, θⁱ₂ and θⁱ₃ after the i-th update operation (step S12). After that, the beam former processing including adaptive filter operations is performed on the delayed input signals (step S3). In the input direction update section 234, the output powers of the beam formers 231, 232 and 233 are computed, the input direction of each of the beam formers is updated in accordance with expressions (22) to (27), and the number of input direction updates is incremented by one (step S14). The procedure then returns to step S12.

The input direction update section 234 repeats steps S12, S13 and S14 until input data is exhausted.

As described above, the eighth embodiment, which is directed to a signal processing apparatus which performs beam-former-based adaptive filtering operations on input signals from transducers in a microphone array in which multiple acoustic-electric transducers (sensors) are arranged in a specific configuration and extracts a signal arriving from a target direction as an output signal while suppressing noise, allows any signal arrival direction in three-dimensional space to be tracked with a straightforward arrangement without using computation-intensive spatial searching and allows a target signal to be extracted accurately though a required amount of computation is small. This owes to the provision of three beam formers: one for extracting an output signal, and two for referencing, those beam formers being arranged such that their respective input directions are variable and set different at initialization time, and an input direction update section which examines output powers of the respective beam formers to compute a quantity of correction of the input directions in accordance with the highest one, computes new input directions corrected by the quantity of correction as updating information, updates the beam former input directions in accordance with the updating information, and repeats this update processing until input data is exhausted.

An incoming signal can be extracted with even higher accuracy by providing, in addition to two or more beam formers used to update the input direction, another beam former having its input direction set between the input directions of those beam formers. This example is described below as a ninth embodiment in the form of an extension to the seventh embodiment. The eighth embodiment can also be extended in a similar manner.

An arrangement of the ninth embodiment is illustrated in FIG. 27. A first beam former 201, which is of a variable-input direction type, performs noise-suppressing filtering operations on multi-channel input signals Sch1, Sch2, . . . , SchM with a previously set direction as its input direction and, upon receipt of updating information addressed to it, updates the input direction accordingly. A second beam former 202, which is also of a variable-input direction type, performs noise-suppressing filtering operations on the multi-channel input signals Sch1, Sch2, . . . , SchM with a previously set direction as its input direction different from that of the first beam former and, upon receipt of updating information addressed to it, updates the input direction accordingly. A beam former 241, which is of variable input direction type and has a direction which is the middle between the input directions of the first and second beam formers previously set as its input direction, performs filtering operations on the multi-channel input signals to suppress noise and output a target signal by suppressing components coming from directions other than the input direction and, upon receipt of updating information addressed to it, updates its input direction accordingly. An input direction update section 242 makes a decision of which of the input directions of the beam formers 201 and 202 an actual signal arrival direction is closer to on the basis of output powers of the beam formers 201 and 202, seeks a quantity of correction of the input direction, correct the input directions of the beam formers 201 and 202 by the quantity of correction to obtain new input directions as updating information for the beam formers 201 and 202, and provides an input direction between the new input directions of the beam formers 201 and 202 as updating information to the beam former 241.

In this apparatus, the input signals are applied to the first, second and third beam formers 201, 202 and 241 and an output signal of the third beam former 241 is used as a final output signal.

In this apparatus, the processing by the first and second beam formers 201 and 202 and the processing by the input direction update section 242 are exactly the same as in the case of the seventh embodiment. The input direction θ₃ of the beam former 241 is set to the middle between the input directions of the beam formers 201 and 202 updated by the input direction update section 242.

That is, the input direction θ₃ of the beam former 241 is set such that

θ₃=(θ₁+θ₂)/2 (28)

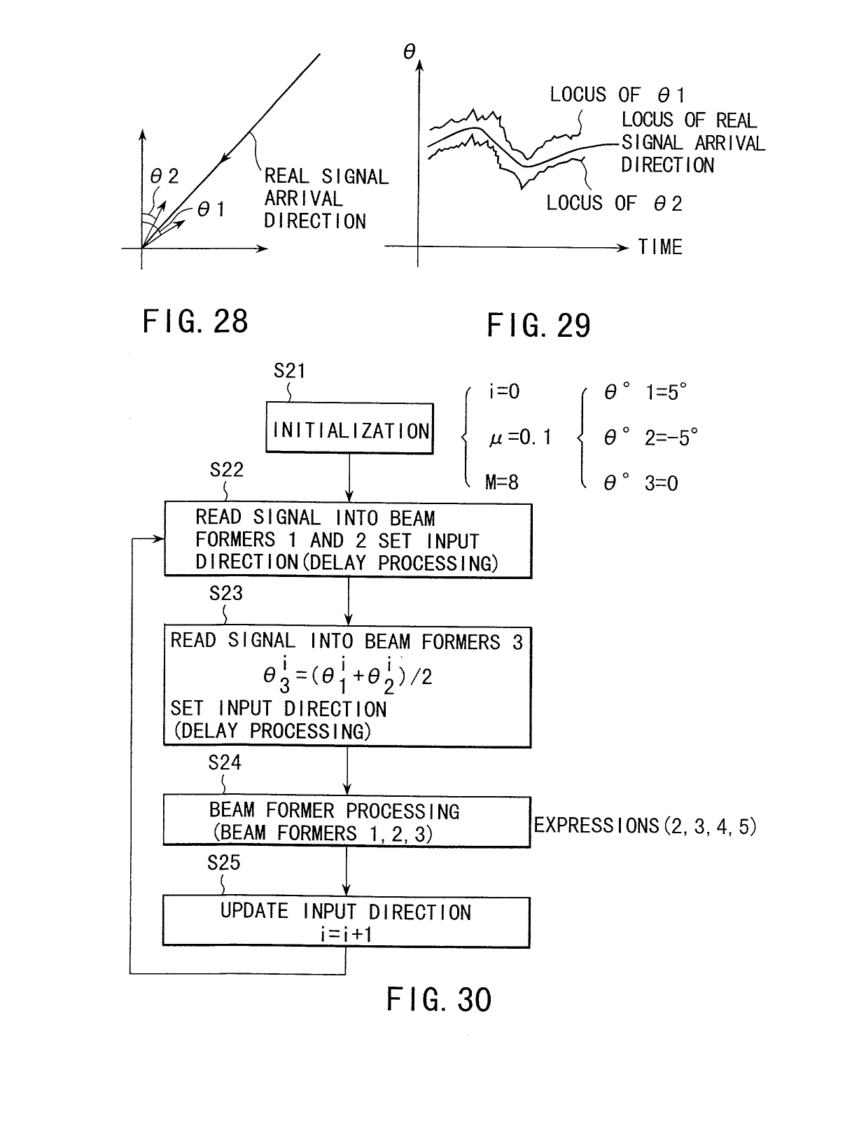

The input directions of the beam formers 201 and 202 are set such that there is a fixed difference therebetween at all times. As shown in FIG. 28, therefore, when the real signal arrival direction reaches the middle between the input directions of the beam formers 201 and 202, the input directions of these beam formers are retained slightly displaced from the real signal arrival direction and follow such loci as shown in FIG. 29, indicating good tracking.

This means that the input direction of each of the beam formers 201 and 202 will not quite match the real signal arrival direction. Since the difference between the input directions is small, the output signal will suffer from little degradation. In the present embodiment, additional beam former 241 is provided which performs beam former processing with its input direction set to the middle between the input directions of the beam formers 201 and 202 for the purpose of bringing about a better coincidence between the input direction and the real signal arrival direction for accurate signal extraction.

The beam former 241 which has its input direction set to the middle between the input directions of the beamformers 201 and 202 may also be used for input direction updating.

The overall process flow of the present embodiment will be described with reference to FIG. 30. The input direction updating is performed at regular intervals and the block-by-block processing is performed with a data length corresponding to the period taken as one block. For example, one block length is 50 samples per channel on the assumption that the sampling frequency is 11 kHz.

First, the initialization is performed to set the input direction updating step size μ, the number of channels M, the initial values θ⁰₁, and θ⁰₂ of the input directions of the beam formers 201 and 202, the filter coefficients of the beam formers all to 0s, and the number of input direction updatings to i=0 (step S21). In the beam formers 201 and 202, input data is read in and then input signals of one block length are delayed on the basis of the input directions θⁱ₁ and θⁱ₂ after the i-th update operation (step S22). In the middle-position beam former 241, input data is read in and θⁱ₃ is computed from expression (28) using the input directions θⁱ₀ and θⁱ₂ after the i-th updating, and an input signal of one block length is delayed on the basis of the resulting input direction θⁱ₃ (step S23). After that, the beam former processing including adaptive filter operations is performed on the delayed input signals in the beam formers 201, 202 and 241 (step S24). In the input direction update section 242, the output powers of the beam formers 201 and 202 are computed, the input direction of each of the beam formers 201 and 202 is updated in accordance with expressions (10) to (13), and the number of input direction updatings is incremented by one (step S25). The procedure then returns to step S22.

The input direction update section 242 repeats steps S22, S23, S24 and S25 until input data is exhausted.

With the ninth embodiment, the use of the third beam former (middle-position beam former) having its input direction set to the middle between the input directions of the first and second beam formers allows the beam former input direction to follow a real signal arrival direction accurately. As a result, an incoming signal can be extracted with high accuracy.

As described above, the ninth embodiment, which is directed to a signal processing apparatus which performs beam-former-based adaptive filter operations on input signals from transducers in a microphone array in which multiple acoustic-electric transducers (sensors) are arranged in a specific configuration and extracts a signal arriving from a target direction as an output signal while suppressing noise, allows any signal arrival direction in three-dimensional space to be tracked with a straightforward arrangement without using computation-intensive spatial searching and allows a target signal to be extracted accurately though a required amount of computation is small. This owes to the provision of three beam formers: one or extracting an output signal, and two for referencing, those beam formers being arranged such that their respective input directions are variable and set different at initialization time, and an input direction update section which examines output powers of the referencing beam formers to compute a quantity of correction of the input directions in accordance with the highest one, updates the input directions of the referencing beam formers to new ones each corrected by the quantity of correction, updates the input direction of the output-signal extracting beam former to a new one which is the middle between the input directions of the referencing beams formers, and repeats this update processing until input data is exhausted.

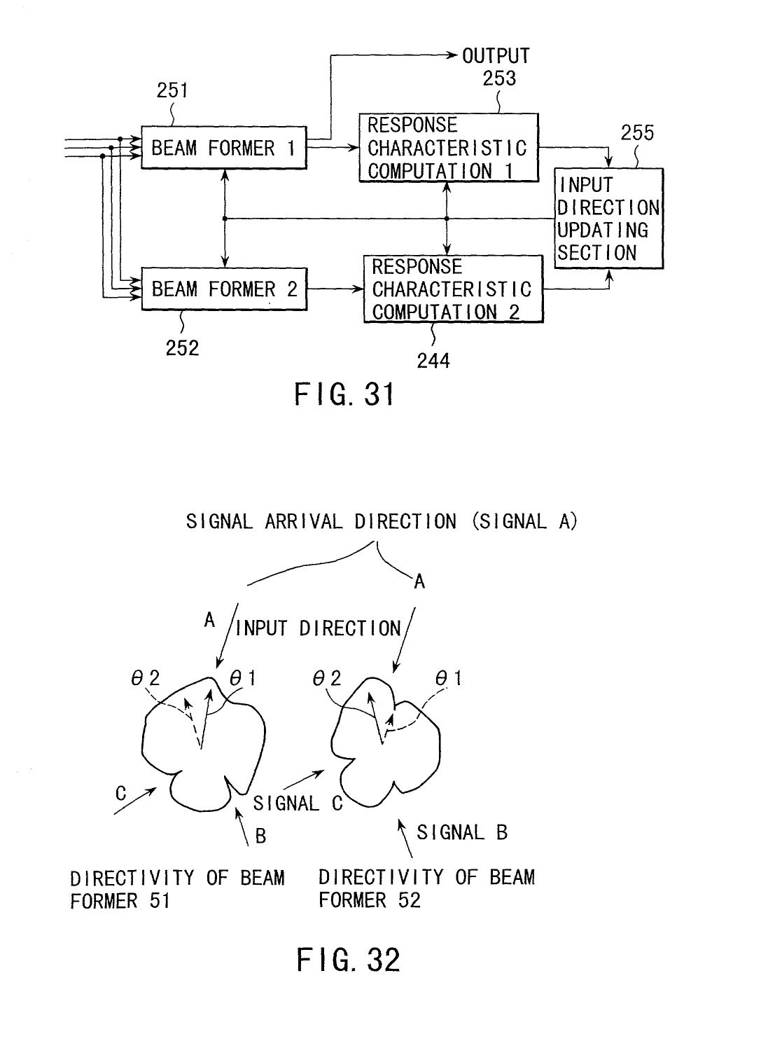

A tenth embodiment for updating beam former input directions on the basis of beam former filter response characteristics as opposed to beam former output powers will be described next with reference to FIG. 31.

In FIG. 31, a first beam former 251 is an input direction variable type beam former which has a previously determined direction set as its input direction, performs filter operations on multi-channel input signals Sch1, Sch2, . . . , SchM to suppress noise and, upon receipt of updating information addressed to it, updates its input direction accordingly. A second beam former 252 is an input direction variable type beam former which has a direction different from that of the first beam former set as its input direction, performs filter operations on multi-channel input signals Sch1, Sch2, . . . , SchM to suppress noise and, upon receipt of updating information addressed to it, updates its input direction accordingly. A first response characteristic computation section 253 computes response characteristics of the first beam former for the input direction of the second beam former 252 from its filter characteristics. A second response characteristic computation section 254 computes response characteristics of the second beam former for the input direction of the first beam former from its filter characteristics. An input direction update section 255 responds to the first and second response characteristic computation sections 253 and 254 makes a decision of which of the input directions of the first and second beam formers an actual signal arrival direction is closer to, seeks a quantity of correction of input direction accordingly, seeks new input directions of the first and second beam formers each corrected by the quantity of correction as updating information, and sends each updating information to a corresponding respective one of the beam formers.

In this apparatus, the multi-channel input signals are applied to each of the first and second beam formers 251 and 252 and an output signal of the first beam former is used as a final output signal of the apparatus.

The response characteristic computation sections 253 and 254 compute the spatial response characteristics of the respective filters in the beam formers from their characteristics.

The response characteristic to a certain direction φ is a filter output power value calculated on the assumption that a signal arrives from that direction. The signal is supposed to be white noise by way of example.

In general, the beam former has a large values for response characteristic for its input direction in order to allow an incoming signal from the input direction to pass unattenuated.

As shown in FIG. 32, in the case where the input direction θ₁ of the beam former 251 is coincident with an actual signal arrival direction, but the input direction θ₂ is not coincident, the filter of the beam former 252, which is adapted to remove a signal, has a low sensitivity for the direction of θ₁.

Thus, by making a comparison between the response characteristic of the second beam former 252 for the direction of θ₁ and that of the first beam former 251 for the direction of θ₂, it can be determined that, when the response characteristic of the first beam former is larger, the signal arrival direction is closer to θ₁; otherwise, it is closer to θ₂.

The use of filter response characteristics, while some amount of computation being involved in computing response characteristics as compared with the use of beam former output powers, has an advantage of being capable of following the signal arrival direction with accuracy because the effect of noise can be reduced.

The response characteristic may be obtained by generating an input signal, which would be observed on the assumption that white noise arrives from the direction of θ₁ or θ₂, on the basis of the method of computing the delay amount as described in the first embodiment and computing an output power of the filter when it is supplied with that signal. Alternatively, the similar computation may be performed in frequency domain, i.e., by Fourier transforming the filter output, generating a complex delayed vector, which would be observed on the assumption that a sinusoidal wave of unit amplitude arrives from the direction of θ₁ or θ₂, for each frequency component, producing an inner product of the complex delayed vector and the corresponding frequency component of the filter output, and adding together squares of such inner products for all the frequency components.

The latter method is disclosed in Japanese Unexamined Patent Publication No. 9-9794 and hence a description thereof is omitted here.

Assuming that the response characteristic of the first beam former 251 for the direction of θ₂ is p1 and the response characteristic of the second beam former 252 for the direction of θ₁ is p1, the computation based on expressions (10) to (14) in the seventh embodiment allows the input direction to be updated as in the seventh embodiment. The other processing is exactly the same as in the case of the seventh embodiment.

As described above, the input direction setting based on the beam former filter response characteristics as opposed to beam former output powers makes it possible to follow the signal arrival direction with even higher accuracy. The method using the filter response characteristics may be applied not only to the first embodiment but to the eighth and ninth embodiments merely by replacing beam former output powers with filter response characteristics.

As described above in detail, a signal processing apparatus of the present invention is provided with a plurality of beam formers which have slightly different directions set as their respective input directions and arranged such that output powers of the beam formers are compared to detect which of the input directions of the beam formers the real signal arrival direction is closer to, and the input direction of each beam former is shifted simultaneously step by step toward the signal arrival direction to thereby track the signal arrival direction. This employs that the farther away the beam former's input direction is from the signal arrival direction, the lower its output becomes as a result of cancellation of a target signal.

This apparatus eliminates the need of computation-intensive space search processing and frequency-domain-based processing and, while being very simple in arrangement, allows robust processing for tracking a target source, which is free of degradation due to cancellation of a target signal.

Another apparatus of the present invention is further provided with a beam former in addition to the above-described plurality of beam formers, which has its input direction set to the middle between the input directions of the beam formers.

The setting of the input direction of the additional beam former to the middle between the input directions of the plural beam formers allows that input direction to follow the signal arrival direction more accurately. Moreover, more accurate target signal extraction is made possible using the output signal of the additional beam former as a target signal than with the output signal of one of the plural beam formers.

In this case, the plural beam formers are used only for tracking and have no direct effect on the output signal of the apparatus, thus providing an advantage that the filter length of those beam formers can be reduced to decrease an overall amount of processing.

According to the present invention, as described above, there can be provided a signal processing apparatus and method which allow a signal arrival direction to be tracked with a simple arrangement without using space search processing that involves a large amount of computation and allows a target signal to be extracted accurately using a small amount of computation while circumventing cancellation of a target signal.

Additional advantages and modifications will readily occurs to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A speech processing method comprising:
a speech signal inputting step of inputting a speech signal over a plurality of channels;
a beam former processing step of subjecting a beam former processing for suppressing a signal arriving from a target source with respect to the speech signal inputted by the speech signal inputting step;
a target source direction estimating step of estimating the direction of the target source from filter coefficients obtained by the beam former processing step; and
a speech interval determining step of determining a speech interval of the speech signal on the basis of the direction of the target source estimated by the target source direction estimating step.

2. The signal processing method according to claim 1, wherein the speech interval determining step determines the speech interval of the speech signal on the basis of the direction of the target source determined by the target source direction estimating step and the power of the speech signal.

3. A signal processing method comprising:
a speech signal inputting step of inputting a speech signal over a plurality of channels;
a first beam former processing step of performing beam former processing on the speech signal inputted by the speech signal inputting step to suppress a signal arriving from a target source;
a target source direction estimating step of estimating the direction of the target source from filter coefficients obtained by the first beam former processing step;
a second beam former processing step of subjecting a beam former processing to the speech signal inputted by the speech signal inputting step to suppress a signal arriving from a noise source and output the signal from the target source;
a noise source direction estimating step of estimating the direction of the noise source from filter coefficients obtained by the second beam former processing step;
a first control step of controlling the beam former processing by the second beam former processing step on the basis of the direction of the target source estimated by the target source direction estimating step and powers of outputs obtained by the first and second beam former processing steps;
a second control step of controlling the beam former processing by the first beam former processing step on the basis of the direction of the noise source estimated by the noise source direction estimating step and the powers of the outputs obtained by the first and second beam former processing steps; and
a speech interval determining step of determining a speech interval of the speech signal on the basis of the direction of the target source estimated by the target source direction estimating step.

4. The signal processing method according to claim 3, wherein the speech interval determining step determines the speech interval of the speech signal on the basis of the direction of the target source determined by the target source direction estimating step and the power of the speech signal.

5. A speech signal processing apparatus comprising:
a speech signal inputting section for inputting a speech signal over a plurality of channels;
a beam former for performing beam former processing on the speech signal inputted by the speech signal inputting section to suppress a signal arriving from a target source;
a target source direction estimating section for estimating the direction of the target source from filter coefficients obtained by the beam former processing section; and
a speech interval determining section for determining a speech interval of the speech signal on the basis of the direction of the target source estimated by the target source direction estimating section.

6. The signal processing apparatus according to claim 5, wherein the speech interval determining section determines the speech interval of the speech signal on the basis of the direction of the target source determined by the target source direction estimating section and the power of the speech signal.

7. A signal processing apparatus comprising:
a speech signal inputting section for inputting a speech signal over a plurality of channels;
a first beam former for performing beam former processing on the speech signal inputted by the speech signal inputting section to suppress a signal arriving from a target source;
a target source direction estimating section for estimating the direction of the target source from filter coefficients obtained by the first beam former processing section;
a second beam former processing section for performing beam former processing on the speech signal inputted by the speech signal inputting section to suppress a signal arriving from a noise source and output the signal from the target source;
a noise source direction estimating section for estimating the direction of the noise source from filter coefficients obtained by the second beam former processing section;
a first control section for controlling the second former on the basis of the direction of the target source estimated by the target source direction estimating section and powers of outputs obtained by the first and second beam formers;
a second control section for controlling the first beam former on the basis of the direction of the noise source estimated by the noise source direction estimating section and the powers of the outputs obtained by the first and second beam formers; and
a speech interval determining section for determining a speech interval of the speech signal on the basis of the direction of the target source estimated by the target source direction estimating section.

8. The signal processing apparatus according to claim 7, wherein the speech interval determining section determines the speech interval of the speech signal on the basis of the direction of the target source determined by the target source direction estimating section and the power of the speech signal.

9. A signal processing method comprising:
a speech signal inputting step of inputting a speech signal over a plurality of channels;
a first beam former processing step of performing beam former processing on the speech signal inputted by the speech signal inputting step to suppress a signal arriving from a target source;
a target source direction estimating step of estimating the direction of the target source from filter coefficients obtained by the first beam former processing step;
a second beam former processing step of performing beam former processing on the speech signal inputted by the speech signal inputting step to suppress a signal arriving from a noise source and output the signal from the target source;
a noise source direction estimating step of estimating the direction of the noise source from filter coefficients obtained by the second beam former processing step;
a first control step of controlling the second beam former processing step on the basis of the direction of the target source estimated by the target source direction estimating step and powers of outputs obtained by the first and second beam former processing steps;
a second control step of controlling the first beam former processing step on the basis of the direction of the noise source estimated by the noise source direction estimating step and the powers of the outputs obtained by the first and second beam former processing steps; and
a speech enhancement step of enhancing a speech signal by suppressing noise contained in the output signal obtained by the second beam former processing step on the basis of at least one of the output obtained by the first beam former processing step and the direction of the target source.

10. The speech processing method according to claim 9, further comprising a speech interval detecting step of detecting a speech interval of the speech signal on the basis of the direction of the target source estimated by the target source direction estimating step and the speech signal enhanced by the speech enhancement step.

11. A signal processing method comprising:
a speech signal inputting step of inputting a speech signal over a plurality of channels;
a first beam former processing step of performing beam former processing on the speech signal inputted by the speech signal inputting step to suppress a signal arriving from a target source;
a second beam former processing step of performing beam former processing on the speech signal inputted by the speech signal inputting step to suppress a signal arriving from a noise source and output the signal from the target source; and
a speech enhancement step of enhancing the speech signal by suppressing noise in the output obtained by the second beam former processing step on the basis of the output obtained by the first beam former processing step.

12. A signal processing method comprising:
a speech signal inputting step of inputting a speech signal over a plurality of channels;
a beam former processing step of performing beam former processing on the speech signal inputted by the speech signal inputting step to suppress a signal arriving from a target source; and
a speech enhancement step of enhancing the speech signal by suppressing noise in a speech signal inputted over any of the plurality of channels on the basis of the output obtained by the first beam former processing step.

13. A signal processing apparatus comprising:
a speech signal inputting section for inputting a speech signal over a plurality of channels;
a first beam former for performing beam former processing on the speech signal inputted by the speech signal inputting section to suppress a signal arriving from a target source;
a target source direction estimating section for estimating the direction of the target source from filter coefficients obtained by the first beam former processing section;
a second beam former processing section for performing beam former processing on the speech signal inputted by the speech signal inputting section to suppress a signal arriving from a noise source and output the signal from the target source;
a noise source direction estimating section for estimating the direction of the noise source from filter coefficients obtained by the second beam former processing section;
a first control section for controlling the second former on the basis of the direction of the target source estimated by the target source direction estimating section and powers of outputs obtained by the first and second beam formers;
a second control section for controlling the first beam former on the basis of the direction of the noise source estimated by the noise source direction estimating section and the powers of the outputs obtained by the first and second beam formers; and
a speech enhancing section for enhancing a speech signal by suppressing noise in the output of the second beam former on the basis of at least one of the output of the first beam former and the direction of the target source estimated by the target source direction estimating section.

14. The speech processing apparatus according to claim 13, further comprising a speech interval detecting section for detecting a speech interval of the speech signal on the basis of the direction of the target source estimated by the target source direction estimating section and a signal having its speech component enhanced by the speech enhancing section.

15. A signal processing apparatus comprising:
a speech signal inputting section for inputting a speech signal over a plurality of channels;
a first beam former for performing beam former processing on the speech signal inputted by the speech signal inputting section to suppress a signal arriving from a target source;
a second beam former for performing beam former processing on the speech signal inputted by the speech signal inputting section to suppress a signal arriving from a noise source and output the signal from the target source; and
a speech enhancing section for enhancing the speech signal by suppressing noise in the output of the second beam former on the basis of the output of the first beam former.

16. A signal processing method comprising:
a speech signal inputting section for inputting a speech signal over a plurality of channels;
a beam former performing beam former processing on the speech signal inputted by the speech signal inputting section to suppress a signal arriving from a target source; and
a speech enhancing section for enhancing the speech signal by suppressing noise in a speech signal inputted over any of the plurality of channels on the basis of the output of the first beam former.

17. A signal processing apparatus comprising:
a plurality of beam formers having their respective input directions set to different directions in advance and updated in accordance with updating information;
an input direction update section for, on the basis of outputs of the beam formers, detecting which of the input directions of the beam formers an actual signal arrival direction is closer to, seeking a quantity of correction for correcting the input directions of the beam formers in accordance with the detected result, changing the input directions of the beam formers by the quantity of correction to obtain new input directions as updating information, outputting the updating information to the beam formers, and repeating this processing; and
a reestablishing section for reestablishing the input directions of the beam formers to updated input directions.

18. The signal processing apparatus according to claim 17, further comprising an additional beam former having its input direction set to the middle of the input directions of the beam formers, an output signal of the additional beam former being obtained as a target signal.

19. The signal processing apparatus according to claim 17, wherein the input direction update section obtains the input direction updating information from response characteristics of the beam formers for their input directions computed from filter coefficients of filters in the beam formers.

20. The signal processing apparatus according to claim 17, wherein the input direction update section introduces a time delay in each of inputted multi-channel signals to set the input direction of each of the beam formers.

21. The signal processing apparatus according to claim 17, wherein the input direction update section obtains updating information representing new input directions of the beam formers by giving a small amount of change to the input directions prior to updating so as to make a shift in either of the input directions set in the beam formers.

22. A signal processing method comprising:
a step of setting each of target input directions of beam formers to a different direction;
a step of performing beam former processing in the beam formers;
an input direction updating step of detecting which of the input directions of the beam formers an actual signal arrival direction is closer to and computing new input directions of the beam formers; and
a step of reestablishing the input directions of the beam formers to updated input directions.

23. The signal processing method according to claim 22, further comprising a step of setting a direction which is the middle of the input directions of the beam formers as the input direction of an additional beam former and a step of performing beam former processing in the additional beam former, an output signal of the additional beam former being outputted as a target signal.

24. The signal processing method according to claim 22, wherein the input direction updating step updates the input direction of each of the beam formers on the basis of response characteristics for the input direction computed from its filter coefficients.

25. The signal processing method according to claim 22, wherein setting of the input directions in the beam formers is performed by introducing a time delay in each of the multi-channel signals.

26. The signal processing method according to claim 22, wherein the input direction updating step updates the input directions of the beam formers by giving a small amount of change to the input directions prior to updating so as to make a shift in either of the input directions set in the beam formers.
